(19) United States
(12) Patent Application Publication
(10) Pub. No.: US 2026/0228452 A1
(43) Pub. Date: Aug. 6, 2026

(54) Multilingual Batch Alignment Training For Language Models

(71) Applicant: Oracle International Corporation, Redwood Shores, CA (US)

(72) Inventors: Amit Agarwal, Seattle, WA (US); Tao Sheng, Bellevue, WA (US); Hansa Meghwani, Bengaluru (IN)

(73) Assignee: Oracle International Corporation, Redwood Shores, CA (US)

(21) Appl. No.: 19/199,099

(22) Filed: May 5, 2025

Related U.S. Application Data
(60) Provisional application No. 63/753,819, filed on Feb. 4, 2025.

(51) Int. Cl. G06F 40/40; G06F 40/35; G06N 3/092

(52) U.S. Cl. CPC G06F 40/40; G06F 40/35; G06N 3/092

(57) ABSTRACT

Techniques for multilingual batch alignment training and/or fine-tuning for language models are included herein. The system generates and/or accesses data points from batches of data having semantically equivalent content across languages and/or semantically equivalent prompts across languages. The prompts include queries related to a topic or a predictive language task. The data points include one or more sets of resources that are semantic equivalents in different languages. Data points for which a resource enables a correct response are used as positive training data points for reinforcement learning. Data points for which a resource does not enable a correct response are considered as negative training data points for reinforcement learning. The data points are used for alignment training and/or other reinforcement learning for generative language models.

### INCORPORTION BY REFERENCE; DISCLAIMER

Each of the following applications are hereby incorporated by reference: Application No. 63/753,819 filed on Feb. 4, 2025. The Applicant hereby rescinds any disclaimer of claim scope in the parent application(s) or the prosecution history thereof and advises the USPTO that the claims in this application may be broader than any claim in the parent application(s).

### TECHNICAL FIELD

The present disclosure relates to training and/or fine-tuning techniques for language models.

### BACKGROUND

Large language models (LLMs) are types of artificial intelligence (AI) models used in various systems. For example, query response systems produce answers to queries, and various other AI systems produce various other outputs. For example, chatbots, agents, or other language model systems deploy large language models to generate natural language responses to user queries. However, traditional language models sometimes provide inaccurate, irrelevant, misaligned or otherwise invalid responses to some queries. Further, traditional systems are often trained with sets of data that include more resources for some languages than for others. In general, for a language model, a language for which training data used to train the model includes many or more resources is considered “high-resource” or “higher-resource” and a language for which the training data set included few or less resources is referred to as a “low-resource” or “lower-resource” language. Traditional systems therefore have inconsistent performance for higher-resource languages as compared to lower-resource languages and/or lose accuracy when deployed in a multilingual context.

Techniques in this disclosure may address any of the aforementioned flaws, challenges, and difficulties by providing techniques that result in improved model outputs. The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 illustrates a language model optimization system using multilingual batch alignment, in accordance with one or more embodiments;

FIG. 2 illustrates example multilingual batch alignment operations, in accordance with one or more embodiments;

FIGS. 3A-G illustrate example multilingual batch alignment techniques in accordance with one or more embodiments;

FIG. 4 illustrates an example machine learning engine in accordance with one or more embodiments;

FIG. 5 illustrates example operations for machine learning in accordance with one or more embodiments; and

FIG. 6 illustrates a block diagram of a computer system in accordance with one or more embodiments.

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form to avoid unnecessarily obscuring the present disclosure.
1. GENERAL OVERVIEW
2. LANGUAGE MODEL OPTIMIZATION SYSTEM
3. MULTILINGUAL BATCH ALIGNMENT TRAINING OPERATIONS
4. MULTILINGUAL BATCH ALIGNMENT TRAINING TECHNIQUES
5. MACHINE LEARNING ARCHITECTURE
6. MACHINE LEARNING OPERATIONS
7. GENERATIVE ARTIFICIAL INTELLIGENCE MODELS
8. COMPUTER NETWORKS AND CLOUD NETWORKS
9. HARDWARE OVERVIEW
10. MISCELLANEOUS; EXTENSIONS

### 1. General Overview

Techniques for multilingual batch alignment are disclosed. The techniques improve multilingual performance of a generative language model. The techniques increase accuracy and/or alignment for different languages in which the language model responds. For example, the techniques are suitable for improving a generative language model component of a multilingual agentic system. The techniques improve various generative language models by constructing batches of data points in a particular manner so that the batches are effective for use during training and/or reinforcement learning for a generative language model.

For example, a batch of data points includes at least a first data point and a second data point. The first data point is constructed based on a prompt that includes an instruction to perform a task using a set of resources. The second data point is constructed based on a prompt that includes an instruction to perform the same task (or a semantically equivalent task) using a second set of resources that has semantically equivalent content relative to the first set of resources. The first data point and the second data point are used as training data during training or reinforcement learning for a generative language model. A training or reinforcement learning framework determines an award or penalty used during training based on the first data point and the second data point to adjust a weight for a parameter of the generative language model to result in an optimized generative language model.

One or more batches are generated using prompts that include parallel tasks that are based on using contexts (e.g., documents, conversations, or other resources) in different languages. The different contexts include different sets of documents (or other resources) that are semantically equivalent but that are written in different languages. The prompt includes instructions for a model to perform different versions of the same task using the sets of semantically equivalent (or semantically similar) resources in the different languages. Due to the parallel structure of the same task being performed using semantically equivalent contexts, the correct responses for the tasks are semantically equivalent.

Aligning the valid responses in the batches of data points for the different languages by including instructions for a model to perform a same task using semantically equivalent sets of resources makes the batches of data points especially useful for machine learning (e.g., training, retraining, optimization, supervised learning, reinforcement learning, etc.) because the model's responses for the task should not be affected by the sets of resources being in different languages. For example, such batches of data points reveal when a language model provides a valid response in a first language but an invalid response in the second language, even though the resources are semantically equivalent. If a model's parameters lead the model to output responses that are correct and equivalent, a reinforcement learning framework assigns a positive reward or weight to the parameters. If the model's parameters lead the model to output responses that are not equivalent, the reinforcement learning framework assigns a negative reward or weight to the parameters. During reinforcement learning, the learning framework adjusts the model's parameters (or weights) so that the responses in the first language and the responses in the second language are valid.

Some batches of data points are used as training data during initial training of a model. Other batches of data points that are generated based on an output from a language model. The output-based batches are used as training data during a retraining or optimization of the language model. Batch alignment training techniques disclosed herein can be applied either to establish more effective initial parameters for a language model and/or to optimize a pretrained model without the need for retraining from scratch. Various learning frameworks accept batches of data points to set and/or adjust parameters of a language model by assigning rewards or adjusting weights of the language model to result in an optimized language model that has improved alignment and accuracy.

Some models are trained using a training data set having multiple languages. In some training data sets with multiple languages, there is a discrepancy in the amount of resources (e.g., training data) for the different languages in the training data set. One or more languages in a set with multiple languages can have a lot of resources while other languages do not have a lot of resources in the training data set. In this case, models may sometimes perform better for languages for which there was a large share of training data in the training data set (e.g., “high-resource languages”), and worse for languages for which there was a small share or no share of training data in the training data set (e.g., “low-resource languages”). Multilingual batch alignment techniques enhance performance across multiple languages, even when there are significant discrepancies in available resources.

By aligning a model, existing knowledge can be leveraged to improve performance across different languages. This reduces biases, inaccuracies, and inconsistencies that can sometimes arise from imbalanced training corpora. Notably, alignment not only benefits low-resource languages, but also enhances performance in high-resource languages and in cases where training data is well-balanced. Furthermore, alignment techniques disclosed herein facilitate better understanding across different languages despite diverse linguistic structures, improving a model's ability to handle variations in grammar, idioms, syntax, slang, etc.

Applicant notes that this Overview is non-limiting in nature, and that additional embodiments and related combinations of features are described in this Specification and/or recited in the claims.

### 2. Language Model Optimization System

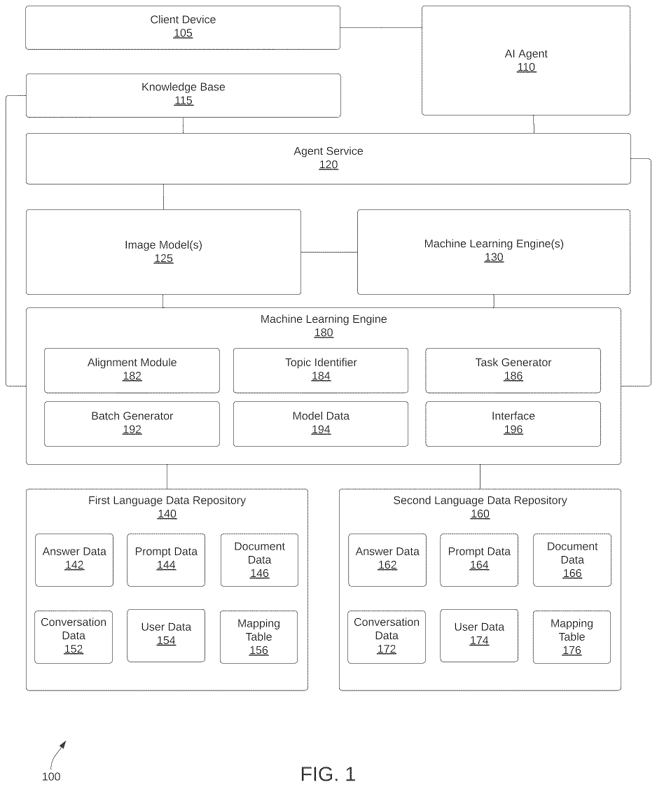

FIG. 1 illustrates a language model optimization system 100 including a client device 105, an AI agent 110, a knowledge base 115, an agent service 120, a machine learning engine 130, a first language data repository 140, a second language data repository 160, and a language model optimization engine 180. In various embodiments, the agent service 120 generates one or more responses to one or more inputs.

In the example the client device 105 refers to a personal computing device such as a smart phone, tablet, or laptop. The client device 105 inputs a prompt or query into the AI agent 110.

The AI agent 110 includes components, such as a language model and/or formatting modules, which receive a text input from a client device 105 and generate a textual response to the input. In some cases, the AI agent 110 comprises a chatbot that deploys services for generating responses or answers. In various embodiments, the language model optimization system 100 includes one or more additional components, in addition to or instead of the AI agent 110, that include a large language model. For example, some embodiments include a retrieval model, a classification model, and/or a summarization model that utilize LLMs. The machine learning engine 130 trains and/or fine-tunes one or more language models 125 deployed by the agent service 120 or by another component of the language model optimization system 100.

In FIG. 1, the client device 105 accesses the AI agent 110 via a user interface. The AI agent 110 interfaces with the agent service 120 which services a response feature of the AI agent 110 by predicting next phrases, taking actions, performing requested tasks, generating responses in a conversation, and/or answering queries based on retrieved resources (e.g., based on retrieved document chunks or other data). Such retrieved resources are stored by and/or hosted in the knowledge base 115 or are stored at other location accessible by the agent service 120. The agent service 120 deploys one or more language models 125. In various embodiments, the agent service 120 deploys a multilingual large language model, or the agent service 120 includes one or more monolingual language models, that may have with multilingual capabilities, and/or a plurality of other language models.

In FIG. 1, the knowledge base 115 refers to a data storage location from which the agent service 120 retrieves resources used to generate responses to queries or other inputs received by the AI agent 110. For example, the knowledge base 115 includes a repository of previous conversations between the AI agent 110 and the client device 105, documents that relate to one or more topics or conversations, or other information. Some resources are related to a topic or service and/or include conversations between the client device 105 and the AI agent 110 related to a topic or service.

In FIG. 1, the agent service 120 utilizes one or more data repositories to store various data. In the example, the agent service 120 stores data related to a first language in a first language data repository 140 and stores data related to a second language in a second language data repository 160.

The first language data repository 140 includes answer data 142, prompt data 144, document data 146, conversation data 152, user data 154, and mapping data 156. The answer data 142, prompt data 144, document data 146, conversation data 152, and/or user data 154 are associated with a first language, and the mapping data 156 maps the data associated with the first language to semantically equivalent data that is associated with other languages.

Likewise, the second language data repository 160 includes answer data 162, prompt data 164, document data 166, conversation data 172, user data 174, and mapping data 176. The includes answer data 162, prompt data 164, document data 166, conversation data 172, user data 174, and mapping data 176 are associated with a second language, and the mapping data 176 maps the data associated with the second language to semantically equivalent data that is associated with other languages. The first language and the second language are languages that the language model(s) are configured to provide output in.

In general, the answer data 142 consists of information that represents responses in a first language generated in relation to queries in the first language, and answer data 162 consists of information that represents responses generated in a second language in response to queries in the second language. The composition of answer data includes formatted text, metadata associated with the response, and references to source materials that contribute to the construction of the answer. In some cases, the structure of answer data incorporates confidence scores, timestamps, and categorization tags to facilitate organization and retrieval. The data storage format of answer data varies, utilizing structured or semi-structured representations such as JSON or XML.

In general, prompt data 144 consists of data that is used as textual or structured language inputs that are in the first language and that are designed to cause a language model for to perform certain operations when formulating a response in the first language. Likewise, prompt data 164 consists of data that is used as textual or structured language inputs that are in the second language and that are designed to cause the language model to perform certain operations when formulating a response in the second language. In embodiments, the composition of the prompt data 144, 164, includes predefined templates, contextual metadata, and/or parameterized input structures that influence the formulation of system outputs. The organization of the prompt data 144, 164, involves categorization based on intent, task type, domain specificity, and/or linguistic structure that facilitates targeted operation testing and targeted response generation. The system stores the prompt data 144, 164 in various formats such as plain text, JSON, or tokenized embeddings.

Document data 146 consists of textual or structured content in the first language that is retrieved and/or stored as a resource used as a reference for processing queries or performing other tasks that are performed using the first language. Document data 166 consists of textual or structured content in the second language that is retrieved and/or stored as a reference for processing queries in the second language. The composition of document data 146, 166 includes formatted text, embedded metadata, and/or structural markers that define sections, headings, and contextual relationships. In some cases, the organization of document data 146, 166 involves hierarchical indexing, tagging, or annotation to facilitate efficient search and retrieval mechanisms. For example, the storage format of document data 146, 166 in various embodiments is either unstructured and/or utilizes structured representations such as XML, JSON, or database entries.

Conversation data 152 consists of text, audio transcripts, or other structured content in the first language that are retrieved and/or stored as a resource for tasks that are performed using the first language. Conversation data 172 consists of text, audio transcripts, or other structured content in the second language that are retrieved and/or stored as a resource for tasks that are performed using the second language. The composition of document data 146, 166 includes formatted text, embedded metadata, and/or structural markers that define sections, headings, and contextual relationships. In some cases, the organization of document data 146, 166 involves hierarchical indexing, tagging, or annotation to facilitate efficient search and retrieval mechanisms. For example, the storage format of document data 146, 166 in various embodiments is either unstructured and/or utilizes structured representations such as XML, JSON, or database entries.

In FIG. 1, user data 154 and user data 174 refer to information related to users of the AI agent 110 and/or of the agent service 120 and/or to user devices used to access the AI agent 110 and/or the agent service 120. User data 154 refers to data that is recorded in relation to the AI agent 110 and/or the agent service 120 being used to answer questions in the first language, whereas user data 174 refers to data that is recorded in relation to the AI agent 110 and/or the agent service 120 being used to answer questions in the second language. In embodiments, the system organizes user data using indexing by user profiles, categorization by activity patterns, or linkage to associated conversations or portions of conversations in the respective languages.

Also, in some embodiments, the first language repository stores mapping data 156, which includes one or more mapping tables between the first language and one or more other languages. The mapping data 156 maps data stored in the first language data repository 140 to related data in different languages. The mapping data 156 includes a mapping of answer data 142, prompt data 144, document data 146, conversation data 152, user data 154, and/or other data, to associated data located in one or more other data repositories, such as the second language data repository 160. Likewise, the mapping data 176 maps data stored in the second language data repository 160 to related data in different languages. The mapping data 176 likewise includes a mapping of answer data 162, prompt data 164, document data 166, conversation data 172, user data 174, and/or other data, to associated data located in one or more other data repositories, such as the first language data repository 140.

As shown, the language model optimization engine 180 includes an alignment module 182, a topic identifier 184, a task generator 186, a batch generator 192, model data 194, and an interface 188.

The alignment module 182 includes components that facilitate fine-tuning of a language model using one or more batches of resources. In various embodiments, the alignment module 182 includes a Direct Preference Optimization (DPO) framework, an Odds-Ratio Preference Optimization (ORPO) framework, or another optimization framework. The optimization framework receives batches of data points as part of an optimization pipeline. The batches of data points include positive data points and/or negative data points. A reward model of the optimization framework adjusts one or more parameters of a language model based on the positive data points and the negative data points to maximize the reward determined by the language model's outputs.

DPO is a technique for fine-tuning AI models by directly optimizing them for preferences, leading to more aligned behavior. ORPO is a technique suitable for machine learning to optimize decision-making by adjusting model parameters to maximize the odds ratio of a preferred outcome. DPO and ORPO focus on improving an LLM's performance for various tasks. For example, reinforcement learning techniques improve performance in reasoning, retrieval, classification, and other tasks, by weighting the LLM's outputs in a way that results in improved predictions by the LLM. Both DPO and ORPO techniques are suitable for improving alignment by using batches of positive data points and/or negative data points to increase and/or decrease parameters related to preferences of a language model.

The topic identifier 184 includes components that identify a topic associated with a resource, conversation, or other corpus. For example, a dataset includes a plurality of documents and/or conversations. The topic identifier includes modules for processing the documents and/or conversations and for identifying one or more topics associated with the documents and/or conversations. In some cases, the topic identifier also generates or identifies a summary or description of the documents or conversations.

The task generator 186 includes a language model or other component that is configured for generating tasks that are answerable by a resource (i.e., a document or conversation) and/or that are related to a particular topic. For example, for a first document related to a particular topic in a first language and a second document that is in a second language and is semantically equivalent to the first document, the task generator 186 produces prompts, instructions, requests, and/or queries cause a model to perform a same task in the respective different languages. In some embodiments, the task generator 186 generates a plurality of tasks associated with a topic, and a plurality of data points in a single batch of data points are associated with a single task in the respective different languages.

The batch generator 192 includes components configured for constructing, extracting, compiling and/or selecting data points to result in a batch of data points. The batch generator includes batches of data points that are based on language tasks in different languages that use semantically similar resources for the different languages. The batch generator 192 accesses the data stored in the first language data repository 140, the second language data repository 160, and/or the knowledge base 115. In some embodiments, the batch generator 192 compiles a set of resources that are in one or more languages. The batch generator 192 generates or otherwise accesses a plurality of sets of different resources in the different languages that are semantic equivalents in the different languages. The batch generator includes ground truths or other responses to tasks involving the different languages that are paired with respective sets of resources in the different languages. The batch generator 192 includes data processing modules, batching algorithms, and/or memory management structures. The batch generator 192 generates various sets of data points including various tasks and different sets of resources. The batches of data points are suitable for use as training data during reinforcement learning or other machine learning.

The language model optimization engine 180 generates one or more batches of data points based at least in part on the data of the knowledge base 115, the data of the first language data repository 140 and/or the data of the second language data repository 160. The data points include positive and/or negative samples for corresponding sets of prompts in various languages paired with one or more resources in the various languages. The batch generator 192 accesses and/or selects one or more resources in the first language and one or more resources in the second language that are selected and/or processed so that the content of a batch includes semantically similar or semantically equivalent content for the first language and the second language.

In general, semantic equivalence and semantic similarity are concepts used to compare the meaning of two pieces of text, whether in the same language or different languages. Semantic equivalence occurs when two texts convey the same meaning, even if phrased differently. Semantic similarity describes two texts that share overlapping meaning but differ in nuance, detail, or implications. In computational linguistics, similarity scores are often used to quantify the degree of equivalence or similarity between texts using methods such as cosine similarity, word embeddings, or transformer-based models. An example threshold for semantic equivalence is a similarity score of 0.9 or higher (out of 1.0), indicating that the texts are nearly identical in meaning. Meanwhile, an example threshold for semantic similarity is a score of 0.7 or higher. Using these thresholds, scores between 0.7 and 0.9 are considered similar but not equivalent. This approach applies to multilingual text comparison as well, where embeddings from transformer-based models are used to assess cross-language similarity. If two sentences in different languages achieve a similarity score above 0.9, they can be regarded as semantically equivalent, whereas scores between 0.7 and 0.9 suggest that they are similar but not equivalent. These example thresholds are exemplary in nature and not limiting. In different embodiments, the system implements higher or lower thresholds for semantic equivalence and/or semantic similarity.

In an embodiments, the batch generator 192 creates a positive sample by pairing a query with one relevant document from a topic that answers the query and one or more irrelevant documents from the topic that do not answer the query. In an example, the batch generator 192 creates a negative sample by pairing the query with one or more irrelevant resources from a different topic. In some embodiments, the batch generator 192 collects responses from a language model that are generated by the model in response to a prompt that contains an instruction, a query, and a set of contexts. The batch generator 192 collects a response that is a positive sample by collecting a response from a language model that is generated by the model in response to a prompt containing a context that answers the query. The batch generator 192 collects a response that is a negative sample by collecting a response from the language model that is generated by the model in response to a prompt containing no context that answers the query. The batch generator 192 collects positive and/or negative samples for a high-resource language, a second language, and one or more additional non-high-resource languages.

In an embodiment, the instructions are in a high-resource language. The query and contexts are in a same language. In embodiments, the query and context for different data points are both in the first language, both in the second language, and/or both in a plurality of other languages. For a particular batch, the queries for the data points of different languages are semantically equivalent translations in the different languages. Also, the contexts for the data points for the different languages are semantically equivalent translations in the different languages. Thus, for data points related to different languages in a batch, the query and contexts of one data point are semantic equivalents to the query and contexts of another data point.

For example, for a particular prompt, instructions in the first language direct the language model used to answer the prompt to indicate whether a context provided with the prompt answers a query provided with the prompt. The batch generator 192 records responses of the language model in association with positive samples for which a context does answer the query and records responses of the language model in association with negative samples for which no context answers the query. The batch generator 192 stores the samples and the associated responses as a batch of data points. The data points are used as training data during optimization and/or alignment training to improve a model's performance for individual language performance and/or for alignment between languages. In some cases, the optimization improves alignment between higher-resource and lower-resource languages for a pre-trained language model trained using a set of resources for which a particular language is high-resource (i.e., has a majority or plurality share of the resources).

Model data 194 comprises parameters, weight matrices, and algorithmic structures that define the behavior of a language model when answering and/or reasoning. Model data 194 includes parameters, weight matrices, and algorithmic structures that define the behavior of the language model(s) 125. The composition of model data 194 includes numerical representations that encode learned patterns, associations, and decision boundaries derived from training datasets. The structural organization of the model data 194 involves layers of neural networks, statistical distributions, or rule-based decision trees, depending on the nature of the model(s). In some use cases, a language model deployed by the agent service generates responses in multiple languages. In such examples, the model data 194 comprise parameters, weight matrices, and algorithmic structures that define the behavior of the language model when answering and/or reasoning using the first language or the second language, respectively.

The interface 196 includes components that use one or more batches of data points to perform machine learning and/or reinforcement training on one or more language models deployed by the agent service. The interface 196 facilitates communication between the language model optimization engine 180, machine learning engines, and/or language model. For example, an interface 196 includes application programming interface (API) endpoints, data transformation modules, and pipelines and/or frameworks (such as DPO or OPRO) that support model alignment, fine-tuning and/or reinforcement learning processes. For example, a ML framework component of the interface 196 incorporates abstraction layers for compatibility with various optimization frameworks, implements various protocols, and/or integrates with backends such as TensorFlow or PyTorch. In embodiments, batches of data points are used to perform reinforcement learning on a trained language model. However, in various embodiments, the batches of data points are used during an initial training of the language model in addition to or instead of during reinforcement learning occurring after initial training.

### 3. Multilingual Batch Alignment Training Operations

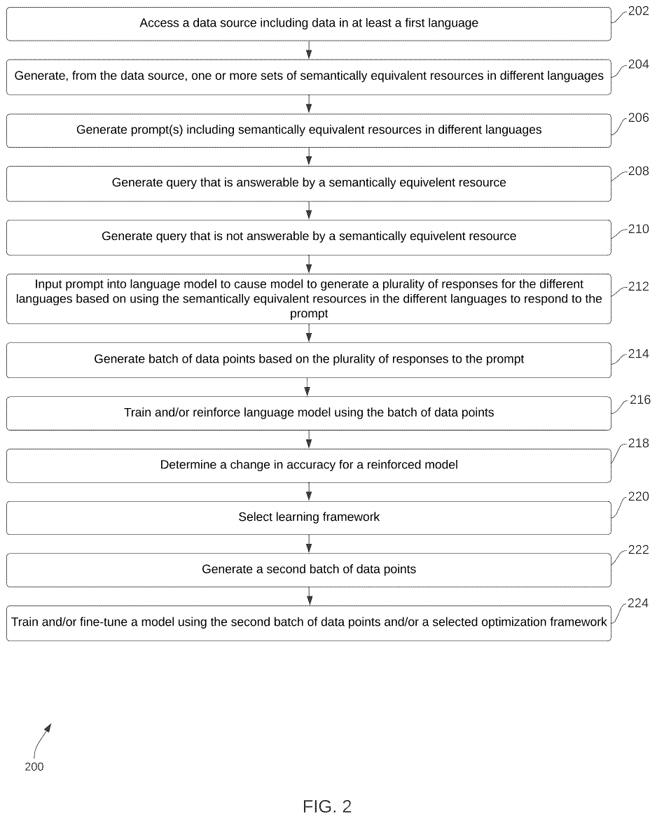

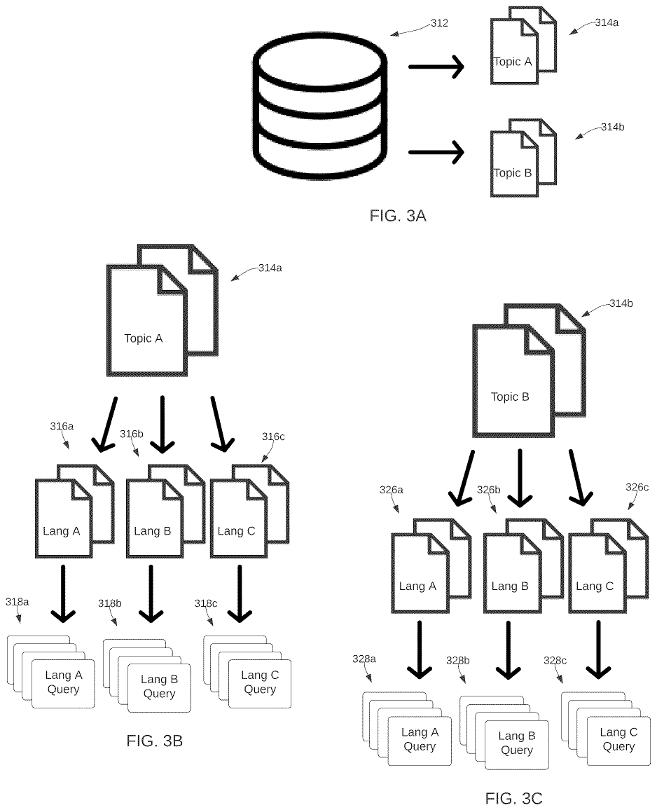

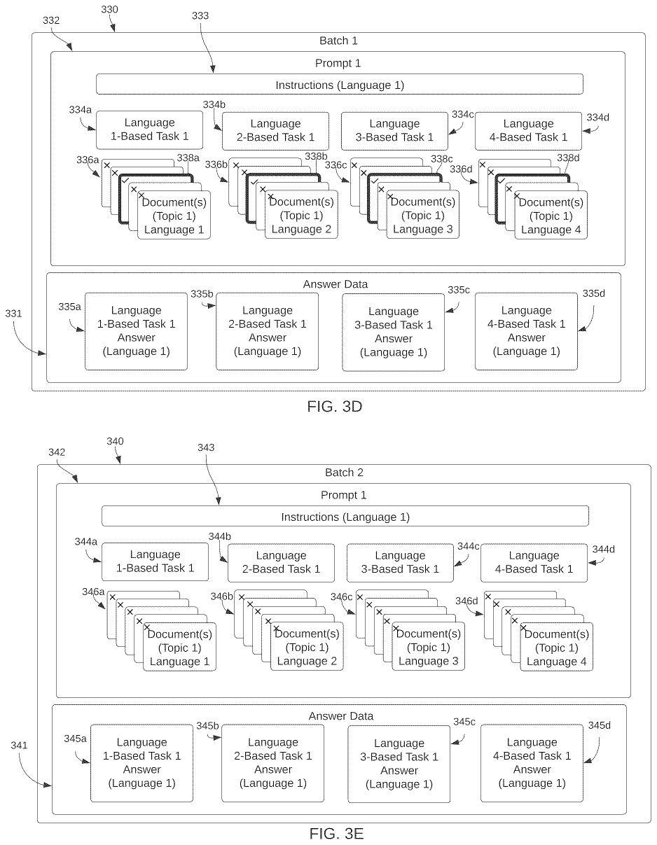

FIG. 2 illustrates example operations for a method 200 of multilingual batch alignment training. For example, the method 200 is performed to improve the performance of one or more language models deployed by a chatbot or an agent service such as the AI agent 110 and/or agent service 120 illustrated in FIG. 1.

In FIG. 2., the system accesses a data source including data in at least a first language (Operation 202). For example, the data source includes a plurality of conversations and/or a plurality of documents in one or more languages. In embodiments, resources from the data source are processed to identify topics associated with the resources and to determine whether the resources include semantically equivalent content for a plurality of different languages. In embodiments, documents and/or conversations include content that is associated with one or more topics or users.

The system generates, from the data source, one or more of sets of semantically equivalent resources in different languages (Operation 204). For example, resources of a data set include documents in different languages that are related to one or more topics. The system selects a plurality of resources (e.g., documents or conversations) that are associated with a particular topic.

The system generates a set of semantically equivalent resources based on the plurality of resources by generating semantic equivalents in different languages for resources for which there are not semantic equivalents in the different languages. For example, a document in a first language that does not have a semantically equivalent document in a second language is translated so that a semantically equivalent document in the second language is included in the set of semantically equivalent resources. The system selects and/or translates resources related to a topic so that the set contains semantically equivalent data items (e.g., documents or conversations) in the different languages that are related to the topic.

In embodiments, one or more resources are written in a high-resource language, and one or more resources are written in a lower-resource language. In various embodiments, the plurality of resources includes a plurality of sets of one or more resources written in the high-resource language and in a respective plurality of languages other than one or more high-resource languages.

The system generates one or more prompts including semantically equivalent resources in the different languages (Operation 206). For example, the system generates a prompt that includes the semantically equivalent resources and an instruction and/or one or more queries.

The system generates or accesses one or more queries the topic associated with the set of semantically equivalent resources. For example, one, two, or more queries are generated for a topic of a set of resources. In embodiments, the prompt includes instructions in a high-resource language, one or more semantically equivalent queries in different languages, and the semantically equivalent resources in the different languages.

In some embodiments, the system receives or accesses the queries. In other embodiments, the system processes the set of semantically equivalent resources to generate queries that are semantically answerable by a definition included in one or more of the resources. The prompt includes instructions requesting a response that indicates whether a resource included in the prompt answers the query. In some cases, the prompt includes instructions requesting a response in a first language, a second language, and/or one or more different languages corresponding to one or more different languages associated with one or more different sets of semantically equivalent resources included with (or referenced by) the prompt.

For example, a prompt includes several sets of semantically equivalent resources for several languages. The prompt also includes instructions in a high resource language. The prompt includes an instruction to answer a set of queries based on respective sets of semantically equivalent resources that are linked to the queries in the prompt. The prompt includes an instruction to answer a query of the set of queries in the high resource language, in a second language, and/or in a language that the query and/or the set of semantically equivalent resources that are linked to the query in the prompt are written in.

In another example, the system identifies a query that is answerable by a document of a plurality of documents and includes semantic equivalents of the query in the different languages in the prompt. The system generates a batch of data points for different languages for the semantically equivalent queries in the different language by inputting the prompt into a language model. In the case that a resource contains an answer to a query, the batch of data points is considered as a batch of positive data points. In some cases, the query is not answerable by the plurality of documents included in the prompt. In such cases, the batch of data points resulting from the prompt being input into the language model are considered as negative data points.

In another example, the prompt includes instructions to predict a letter, word, phrase, or other language component, with a highest likelihood of being valid (e.g., being the next letter, word, or phrase) based on a context. For example, the prompt is a request to predict a next phrase or missing phrase of a conversation included in a resource and/or as context. The system accesses a ground truth to determine the validity of the prediction. The ground truth includes a plurality of semantically equivalent ground truths for a plurality of languages. The ground truth contains one or more correct phrases in the one or more different languages. The system compares the predicted phrase to the ground truth to determine the validity of a prediction. The system uses the validity of the predictions as training data to reinforce the language model for a predictive language task.

The system generates a query that is answerable by a semantically equivalent resource (Operation 208). In this operation, the system generates or accesses a query that is answerable by one or more documents included in the prompt with the query. The prompt includes semantically equivalent queries for different languages that are associated with semantically equivalent sets of documents for the different languages in the prompt. In various embodiments, the system generates one or more prompts including one or more queries for a topic of the documents. A prompt for generating a positive batch of data point includes a document in a language that answers a query in the language. In embodiments, the prompt also includes one or more documents associated with the topic that do not answer the query.

The system generates a query that is not answerable by a semantically equivalent resource (Operation 210). In this operation, the system generates or accesses a query that is not answerable by the documents included in the prompt with the query. The prompt includes semantically equivalent queries for different languages that are associated with semantically equivalent sets of documents for the different languages in the prompt. In various embodiments, the system generates one or more prompts including one or more queries. In different embodiments, the query is related to a same topic or a topic that is different from one or more of the documents. A prompt for generating a negative batch of data point includes no document in a language that answers the query in the language. In embodiments, the prompt includes a plurality of documents associated with a different topic and that do not answer the query.

The system inputs the one or more prompts into a language model to cause the model to generate a plurality of responses for the different languages based on using the semantically equivalent resources in the different languages to respond to the prompt. (Operation 212). For example, the system inputs one or more prompts for generating positive batches of data points and/or one or more prompts for generating negative batches of data points into the language model and records one or more results produced by the model in association with the one or more prompts. In another example, the system inputs a prompt instructing the language model to predict a one or more next phrases for a plurality of semantically equivalent conversations in different languages that are included in the prompt. In this example, the system records the results of the language model in association with the prompt instructing the model to predict the next phrase. The results are compared to a ground truth to determine whether a result is valid or correct based on whether the result matches the ground truth.

The system generates a batch of data points based on the plurality of responses to the prompt (Operation 214). In various embodiments, the system generates one or more batches of data points using prompts that include semantically equivalent instructions and/or and semantically equivalent resources. For example, a prompt includes semantically equivalent queries for a plurality of languages including two or more lower-resource languages and/or a semantically equivalent query for one or more high-resource languages. A first batch of data points for a first language is generated for a first topic, and a second batch of data points for the first language is generated for a second topic. In embodiments, the system generates a batch of positive data points for a first language using a prompt that includes a query that is answerable by a document in the prompt, and/or the system generates a batch of negative data points using a prompt that includes a query that is not answerable by the documents included with the prompt. In embodiments, the system generates a plurality of batches of data points for a plurality of topics based on a plurality of semantically equivalent resources (i.e., documents or conversations) and a plurality of semantically equivalent queries.

In embodiments, the system generates a batch of positive data points based on (a) semantically equivalent queries for a plurality of languages, (b) semantically equivalent resources in the plurality of languages that include respective semantically equivalent valid responses to the queries in the plurality of languages, and (c) resources in the plurality of languages that do not include a valid response to the query. In embodiments, the system generates a negative data point based on a query and based on the resources for the query in the prompt not including a valid response to the query.

In embodiments, the system generates a plurality of positive data points and a plurality of negative data points for a first query, a plurality of languages and a first topic. The plurality of positive data points are included in a batch of data points. The negative data points are included in a batch of data points. In embodiments, the system generates a plurality of batches of positive data points and a plurality of batches negative data points for a plurality of queries, the plurality of languages and the first topic. In embodiments, the system generates a plurality of positive data points and a plurality of negative data points for a plurality of queries for topics of a plurality of topics.

In embodiments, the system generates a plurality of batches for a particular training cycle. In some cases, the plurality of batches are batched by topic. For example, for a topic, the system accesses one or more queries for the topic for a plurality of different languages (e.g., two queries for five languages, for fifteen languages, or more or less queries for more or less languages). The one or more queries for the topic for the plurality of languages are semantically equivalent across the plurality of languages (i.e., a query and the associated resources have semantic equivalents in the plurality of languages).

In some embodiments, the system performs reinforcement learning on a generative language model by: accessing a one or more data points of a first batch of data points including a first data point, the first data point comprising: (a) a prompt in a first language, (b) a resource in the first language including a valid response to the prompt in the first language in the resource, and (c) one or more resources in the first language not including the valid response to the prompt in the first language in the one or more resources.

In this example, the system accesses a second data point of a second batch of data points, the second data point comprising: (a) the prompt in the first language (b) a plurality of resources in the first language not including the valid response to the prompt in the first language in the plurality of resources.

In this example, the system accesses a third data point of a third batch of data points, the third data point comprising: (a) a prompt in a second language and (b) a resource in the second language including a valid response to the prompt in the second language in the resource, and (c) one or more resources in the second language not including the valid response to the prompt in the second language in the one or more resources.

In this example, the system accesses a fourth data point of a fourth batch of data points, the fourth data point comprising: (a) the prompt in the second language and (b) a plurality of resources in the second language not including the valid response to the prompt in the second language in the plurality of resources.

In this example, the system uses the batch of data points to train the generative language model to produce a trained generative language model. The first data point and the third data point in this example are used as positive alignment training data for the first language and the second language, respectively. The second data point and the fourth data point are used as negative alignment training data for the first language and the second language, respectively.

The system trains and/or reinforces the language model using the batch of data points (Operation 216). For example, the system accesses a first data point of the batch of data points and a second data point of the batch of data points. Batches of data points inform the language model which queries are being answered consistently by the model and/or which queries are being answered inconsistently by the model. This information is used to determine the reward provided to the model by a reward model during training and/or fine-tuning.

In embodiments, the first data point includes the model's response that is based on resources in a first language. The second data point includes the model's response that is based on resources in a second language. In various embodiments, the prompt is configured such that the response that is based on resources in the first language and the response that is based on resource in the second language are requested to be in the first language, the second language, or a language matching corresponding resources. Since the resources in the first language and the resources in the second language are semantically equivalent, the model's responses should be the same regardless of the language of the resources or the language requested for the responses. Alternatively, in some embodiments, no language is specified in the prompt for the requested responses.

The system accepts consistent and/or accurate data points as positive feedback for a reinforcement learning framework used to train, fine-tune, and/or optimize a language model. The system accepts inconsistent and/or inaccurate data points as negative feedback for the reinforcement learning framework. Example frameworks include Odds Ratio Preference Optimization (ORPO) and Deep Preference Optimization (DPO). In embodiments, the system performs a plurality of training and/or optimization steps using a plurality of batches. For example, a plurality of batches corresponding to a plurality of positive samples and a plurality of negative samples for a topic and a plurality of languages is used to train and/or tune a model using DPO, ORPO, or other techniques.

The system determines a change in accuracy for a reinforced model (Operation 218). For example, the system measures an initial accuracy of a pretrained generative language model. The system measures a resulting accuracy following reinforcement learning (or other training and/or fine-tuning) of the model using the data points from the batch of data having semantically equivalent content across languages as resources.

The system measures the accuracy of model following training using randomized data and using data points batch of data points. The system determines one or more changes in accuracy between an initial model and a model trained for alignment using various optimization techniques, or between a model trained without batch alignment and a model trained using batch alignment for a particular optimization technique. In some embodiments, a plurality of accuracies are measured for a plurality of languages, batch numbers, batch sizes, and/or topics.

The system selects a learning framework (Operation 220). For example, different learning frameworks include Reinforcement Learning with Human Feedback (RLHF), supervised Fine-Tuning (SFT), Proximal Policy Optimization (PPO), DPO, ORPO, and other techniques. The system selects an optimization framework based on a performance metric, such as an accuracy score. For example, the system selects a learning framework based on the framework having a relatively higher or highest accuracy score. In various embodiments, the optimization framework is selected based on accuracy scores for a particular topic, user, service, and/or language based on a corresponding accuracy score or scores for the topic, user, service, and/or language. The system selects the best framework based on accuracy score and/or other criteria.

The system generate a second batch of data points (Operation 222). In an embodiment, the system generates a batch of data points for a second topic. In various embodiments, the system generates a first plurality of batches of data points for a first training cycle and a second plurality of batches of data points for a second training cycle. In embodiments, a plurality of batches of data points are used during an initial training cycle. One or more pluralities of batches of data are used during a reinforcement learning, optimization phase, and/or fine-tuning phase of a pre-trained model. In various embodiments, the second batch is generated to include resources for a particular topic, user, service, and/or language based on a corresponding accuracy score or scores for the topic, user, service, and/or language indicating relatively lower accuracy. For example, topics are weighted according to proportions of accuracy scores for topics such that topics with lower accuracy scores have proportionally more data points.

The system trains and/or fine-tunes a model using the second batch of data points and/or a selected optimization framework (Operation 224). In embodiments, one or more optimization frameworks are selected based on performance. For example, one, two, or more, highest performing optimization frameworks are selected. In various embodiments, the system trains and/or fine tunes the model iteratively to continuously improve performance of the model using one or more of the selected frameworks.

### 4. Multilingual Batch Alignment Techniques

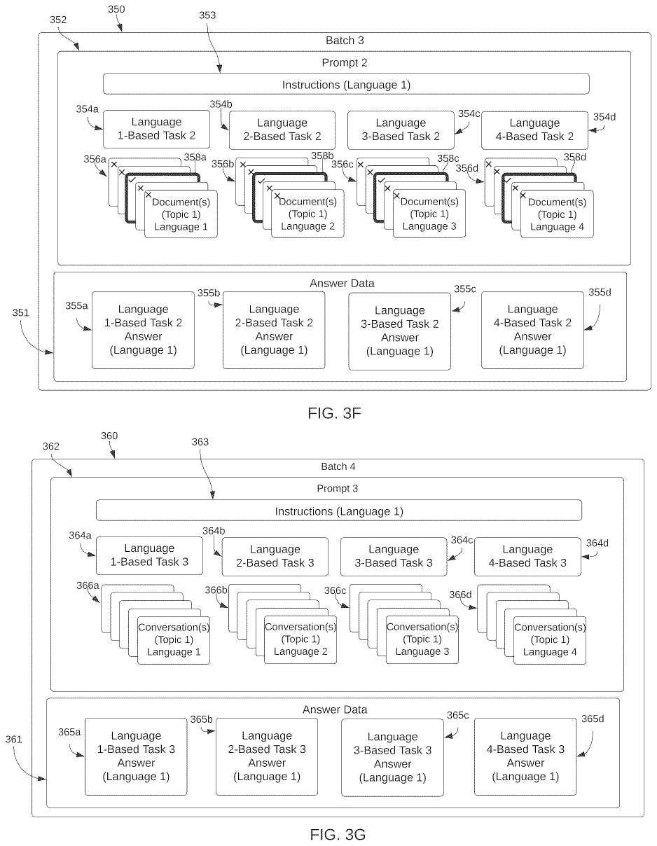

FIG. 3A illustrates a data source 312 that contains a first plurality of resources 314a associated with a first topic and a second plurality of resources 314b associated with a second topic. In various embodiments, the data source 312 includes any number of sets of documents associated with respective topics. In other embodiments, the data source 312 includes any number of sets of conversations associated with respective topics. In some cases, the data source includes conversations associated with one or more users of a chatbot or conversers in the conversation.

In FIG. 3A, the first plurality of resources 314a includes the resources contained in the data source 312 that are associated with the first topic. The second plurality of resources 314b includes the resources contained in the data source 312 that are associated with the second topic. The data source 312 optionally includes one or more other pluralities of resources that are associated with one or more other topics. In the example of FIG. 3A, the first plurality of resources 314a and the second plurality of resources 314b include documents that are written in a high-resource language.

FIG. 3B illustrates generation of a set of documents and queries associated with the first plurality of resources 314a that are semantic equivalents in a plurality of languages. In FIG. 3B, the resources of the first plurality of resources 314a are used to generate a first set of resources 316a in a first language, a second set of resources 316b, in a second language, that includes documents that are semantically equivalent to documents in the first set of resources 316a, and a third set of resources 316c that includes documents that are semantically equivalent to documents in the first set of resources 316a and documents in the second set of resources 316b.

In FIG. 3B, the system generates or otherwise receives one or more queries 318a in the first language that are answerable by the first set of resources 316a. In embodiments, the system additionally or instead generates or otherwise receives one or more queries 318a in the first language that are not answerable by the first set of resources 316a. Language model responses to the answerable queries are considered as positive alignment data points in a batch of data points, whereas language model responses to the not-answerable queries are considered as negative alignment data points in a batch of data points. As shown in FIG. 3B, the system likewise generates or otherwise receives one or more queries 318b in the second language that are or are not answerable by the second set of resources 316b. The system likewise generates or otherwise receives one or more queries 318c in the third language that are or are not answerable by the third set of resources 316c.

FIG. 3C illustrates the generation of a set of documents and/or queries associated with the second plurality of resources 314b that are semantic equivalents in the plurality of languages. In FIG. 3C, the resources of the second plurality of resources 314b are used to generate a second set of documents 326a in a first language, a second set of documents 326b in a second language that is semantically equivalent to the first set of documents 326a, and a third set of documents 326c that is semantically equivalent to the first set of documents 326a and the second set of documents 326b.

In the example of FIG. 3C, the system generates or otherwise receives one or more queries 328a in the first language that are answerable by the first set of documents 326a. In embodiments, the system additionally or instead generates or otherwise receives one or more queries 328a in the first language that are not answerable by the first set of documents 326a. The system likewise generates or otherwise receives one or more queries 328b in the second language that are or are not answerable by the second set of documents 326b. The system likewise generates or otherwise receives one or more queries 328c in the third language that are or are not answerable by the third set of documents 326c.

FIGS. 3D-G, illustrate a first batch 330 of data points, a second batch 340 of data points, a third batch 350 of data points of data points, and a fourth batch 360 of data points. In various embodiments, a batch of data points includes a data point comprising one or more of: a prompt instructing a language model to produce a response by indicating whether a document includes an answer to a query, the query, the document, the response to the prompt generated by the language model, and/or an indication of whether the document does include the answer to the query. A batch of data points includes a plurality of data points associated with a plurality of languages. In some embodiments, the prompt includes an instruction in a first language for a model to response to the prompt using different sets of semantically similar resources for different languages that correlate to the different languages. In other embodiments, the prompt includes an instruction in the different languages for the model to respond to the prompt. Batches of data points include a ground truth and/or a response generated by a language model. The response is compared to a ground truth to identify a positive or negative result during reinforcement learning.

Suitable prompts include prompts that have instructions in a first language that instruct the model to produce the responses for the different languages or prompts that have instructions in the different languages that the model follows to produce the responses. In both cases, the instruction include instructions to perform different semantically equivalent tasks that involve the different languages and semantically equivalent resources in the different languages. In other words, the prompt may include instructions in a first language that instruct a model to respond by performing a task using a second language or may include instructions for the second language.

In FIG. 3D, the first batch 330 (Batch 1) includes a prompt 332 (Prompt 1), and answer data 331. The prompt 332 comprises instructions 333, different semantically equivalent versions 334a-d of a task (Task 1), and different semantically equivalent sets of documents 336a-d that include semantically equivalent versions of the same documents in different languages.

The different semantically equivalent versions 334a-d of the task include a first version 334a of the task that is associated with the first plurality of documents 336a, a second version 334b of the task that is associated with the second plurality of documents 336b, a third version 334c of the task that is associated with the third plurality of documents 336c, and a fourth version 334d of the task that is associated with the fourth plurality of documents 336d. The different versions 334a-d of the task use the resources in the different languages to perform the first task. In different embodiments, the different versions of the task 334a-d are defined separately in the second prompt 352 and/or are performed as a result of the instructions 353 including an instruction to perform the different versions 334a-d of the task based on using the sets of resources (e.g., the pluralities of documents) in languages corresponding to the different versions 334a-d of the task.

In the example, the prompt 332 includes and/or references a first plurality of documents 336a, a second plurality of documents 336b, a third plurality of documents 336c, and a fourth plurality of documents 336d. As shown, the first plurality of documents 336a includes a valid answer 338a, in the first language, to the first version 334a of the first task, the second plurality of documents 336b includes a valid answer 338b, in the second language, to the second version 334b of the first task, the third plurality of documents 336c includes a valid answer 338c, in the third language, to the third version 334c of the first task, and the fourth plurality of documents 336d includes a valid answer 338d, in the fourth language, to the fourth version 334d of the first task.

The answer data 331 refers to one or more answers for the different languages related to inputting the prompt 332 into a language model. For example, the answer data 331 includes a ground truth in a first language for the different languages, different ground truths for the different languages, and/or answers generated by a model for the different languages. The prompt 332 includes instructions 333 that instruct the language model to perform different semantically equivalent versions of the task for different languages. In some cases, answer data 331 refers to answers generated by a model in response to the prompt that are extracted from the model and included in the first batch 330 during construction of the first batch 330. In other embodiments, however, answer data 331 refers to a ground truth (in the first language or in the different languages). In such embodiments, the answer data 331 may not include previous output from a model. In the example of FIG. 3D, answer data 331 includes ground truths that define valid responses to the different versions 334a-d of the task respectively using the pluralities of documents 336a-d that correspond to the different languages of the different versions 334a-d of the task.

In FIG. 3D the answer data 331 includes a first answer 335a to the first version of the first task that is based on the first plurality of documents 336a in the first language. The answer data 331 includes a second answer 335b to the second version of the first task that is based on the second plurality of documents 336b in the second language. The answer data 331 includes a third answer 335c to the third version of the first task that is based on the third plurality of documents 336c in the third language. Likewise, the answer data 331 includes a fourth answer 335d to the fourth version of the first task that is based on a fourth plurality of documents 336d in the fourth language. In the example, the first plurality of documents 336a, the second plurality of documents 336b, the third plurality of documents 336c, and the fourth plurality of documents 336d are semantic equivalents in the first, second, third, and fourth languages, respectively. The first plurality of documents 336a, the second plurality of documents 336b, the third plurality of documents 336c, and the fourth plurality of documents 336d are optionally related to a same topic.

Batches of data points consisting of such prompts and answer data are suitable for use as training data for training or optimizing a language model. In an embodiment, ground truth answer data, and a corresponding prompt are provided as training data during training of a language model without a previous output of the model. Alternatively or in addition, the system includes answer data generated by a model in a batch of data points and uses such a batch as training data to fine-tune the model.

As illustrated in FIG. 3E, the second batch 340 includes a prompt 342 and answer data 341. The prompt 342 comprises instructions 343, different semantically equivalent versions 344a-d of a task (Task 1), and different semantically equivalent sets of documents 346a-d that include semantically equivalent versions of the same text in different languages. In the example, the task is The second batch 340 is similar to the first batch 330 except that the pluralities of documents 346a-d do not include a valid answer to a query.

The different semantically equivalent versions 344a-d of the task include a first version 344a of the task that is associated with the first plurality of documents 346a, a second version 344b of the task that is associated with the second plurality of documents 346b, a third version 344c of the task that is associated with the third plurality of documents 346c, and a fourth version 344d of the task that is associated with the fourth plurality of documents 346d. The different versions 344a-d of the task use the resources in the different languages to perform the task. In different embodiments, the different versions 344a-d of the task are defined separately in the prompt 342 and/or are performed as a result of the instructions 343 including an instruction to respectively perform the different versions 344a-d of the task for the pluralities of documents 346a-d.

In the example, the prompt 342 includes and/or references a first plurality of documents 346a, a second plurality of documents 346b, a third plurality of documents 346c, and a fourth plurality of documents 346d. In this example, the different versions 344a-d of the task are different versions of a same query about the content of the pluralities of documents 346a-d. The second batch 340 is similar to the first batch 330 except that the pluralities of documents 346a-d do not include valid answers to the different versions 344a-d of the task (i.e., to the query).

In this example, the prompt 342 includes instructions 343 that instruct the language model to answer whether the resources include a valid response or answer to the task (e.g., to indicate whether a query is answerable by information in the resources). In this example, a version of the task is to answer positively or negatively with an indication (e.g., yes or no) whether a set of resources in a particular language answers the query. Since the resources do not include a valid answer, the ground truth in this example is a negative indication. A data point for which a correct response is a negative response may be referred to as a negative data point and used a negative training data, and a batch of such data points may be referred to as a negative batch or a batch of negative data points. For negative data points, different responses from a model are still considered correct or incorrect based on whether the response correctly identifies that a query is not answerable by the associated resources. In embodiments, the instructions request for the indications to be in the first language and/or in the different languages.

Regardless, positive and/or negative batches of training data are suitable in various embodiments as training data used during training of a language model without a previous output of the model. Alternatively or in addition, the system includes answer data generated by a model in positive and/or negative batches of training data that are used to fine-tune the model. In the examples, the first batch 330 includes positive data points and the second batch 340 includes negative data points that are constructed based on a same topic and same task.

In FIG. 3F, the third batch 350 includes a second prompt 352 and answer data 351. The third batch 350 is similar to the first batch 330 except that the second prompt 352 includes a second task (Task 2) that is associated with the first topic but that is different from the first task associated with the first topic. In the example, the first task is a first query associated with a first topic, and the second prompt 352 includes a second task that is a second query associated with the first topic that is different from the first query associated with the first topic. The second prompt 352 includes semantically equivalent versions 354a-d of the second query in the different languages that are respectively associated with the sets of documents 356a-d in the different languages.

In this example, the first plurality of documents 356a includes a valid answer 358a, in the first language, to the first version 354a of the second query, the second plurality of documents 356b includes a valid answer 358b, in the second language, to the second version 354b of the second query, the third plurality of documents 356c includes a valid answer 358c, in the third language, to the third version 354c of the second query, and the fourth plurality of documents 356d includes a valid answer 358d, in the fourth language, to the fourth version 354d of the second query. The second prompt 352 includes instructions 353 that instruct the language model to perform the different semantically equivalent versions 354a-d of the second query (Task 2) for the different languages.

In this example, the answer data 351 refers to one or more answers for the different languages related to inputting the second prompt 352 into a language model. For example, the answer data 331 includes a ground truth in a first language for the different languages, different ground truths for the different languages, and/or answers in the different languages that were output by a model in response to the instructions.

The system generates any number additional batches using a prompt containing one or more different queries associated with the first topic to generate additional answers. The system generates additional batches using one or more prompts containing one or more different queries associated with a second topic. In various embodiments, the system generates any number of batches associated with any number of respective topics. For a topic, the system generates any number of batches associated with any number of queries.

FIG. 3G, illustrates a fourth batch 360 of data points including a prompt 362 and answer data 361. In FIG. 3G, the fourth batch 360 is generated using a prompt 362 comprising instructions for a language model to respond to the prompt by performing a task (Task 3). In this example, different suitable tasks include predicting a word or phrase, identifying a tone, sentiment, style or intent, predicting a speaker, or another other language processing task. The language processing tasks are performed based on conversations referred to by or included in the prompt.

In the example of FIG. 3G, the instructions 363 instruct the language model to generate a response based on conversations 366a, 366b, 366c, 366d that are semantic equivalents in the first language, the second language, the third language, and the fourth language, respectively. The response is generated by performing different semantically equivalent versions 364a-d of the task using the conversations 366a, 366b, 366c, 366d as resources.

In FIG. 3G, different semantically equivalent versions 364a-d of the task (Task 3) include a first version 364a of the task that is associated with the first set of conversations 366a, a second version 364b of the task that is associated with the second set of conversations 366b, a third version 364c of the task that is associated with the third set of conversations 366c, and a fourth version 364d of the task that is associated with the fourth set of conversations 366d. The different versions 364a-d of the task use the sets of conversations 366a-d in the different languages to perform the different versions 364a-d of the task. In different embodiments, the different versions 364a-d are defined separately in the prompt 362 and/or are performed as a result of the instructions 363 including an instruction to perform the different versions 364a-d of the task for the different sets of conversations 366a-d.

In the example, the instructions 363 instruct the model to predict the next phrase of a conversation. In some cases, the instructions 363 instruct a model to predict a next phrase of a conversation for a first speaker or another speaker (e.g., for different speakers or authors in conversations involving one or more different users and/or response model components). In the example, the resources include a plurality of conversations (e.g., a conversation history) between a first speaker and a second speaker.

In the example, the prompt 362 includes instructions 363 for the model to predict next phrases or missing phrases of the conversations 366a-d. In other embodiments, however, the prompt includes instructions to predict a sentiment, tone, or intention, or to perform another language processing task. In some cases, the instructions 363 instruct the language model to respond with a sentiment, tone, or intent in a first language. The instructions 363 optionally instruct the language model to respond with a sentiment, tone, or intent in the respective different languages.

In some cases, the instructions request a binary answer (i.e., a yes or no answer) to a language processing task. For example, the instructions request a yes or no answer in a first language based on the results of the language processing tasks (e.g., identifying a sentiment or tone, predicting a phrase, etc., by asking the model to respond indicating whether a particular sentiment, tone, or phrase is identified or predicted, such as with a “yes or no” answer or other binary indicator. For example, the prompt may instruct the model to identify whether the tone of a resource is happy. Another prompt may instruct the model to identify whether a geographical location having a specified attribute is identified in the resources. The instructions optionally instruct the model to respond with binary answers in the first language, which may be a high resource language, or optionally in the different languages.

In the example of FIG. 3G, the prompt 362 includes an instruction for a language model to complete the first version 364a of the task by responding with a first predicted phrase 365a in the first language based on the one or more conversations 366a in the first language. The instructions 363 instruct the language model to complete the second version 364b of the task by responding with a second predicted phrase 365b in the second language based on the one or more conversations 366b in the second language. The instructions 363 instruct the language model to complete the third version 364c of the task by responding with a third predicted phrase 365c in the third language based on the one or more conversations 366c in the third language. The instructions 363 instruct the language model to complete the fourth version 364d of the task by responding with a fourth predicted phrase 365d in the fourth language based on one or more conversations 366d in the fourth language. In some embodiments, the instructions instruct the model to indicate in the first language (e.g., yes or no) whether a predicted phrase matches a specified phrase.

In the example of FIG. 3G, the answer data 361 includes one or more ground truths that include one or more valid next phrases or missing phrases. In other embodiments, answer data includes one or more valid responses to another language processing task. In yet other embodiments, answer data includes valid yes or no responses to a question about a result of a language processing task, such as an indication of whether the first predicted phrase 365a, the second predicted phrase 365b, the third predicted phrase 365c, and/or the fourth predicted phrase 365d match one or more ground truths. The fourth batch 360 is suitable as training data during optimization and/or reinforcement learning of the language model, to result in an optimized language model.

### 5. Machine Learning Architecture

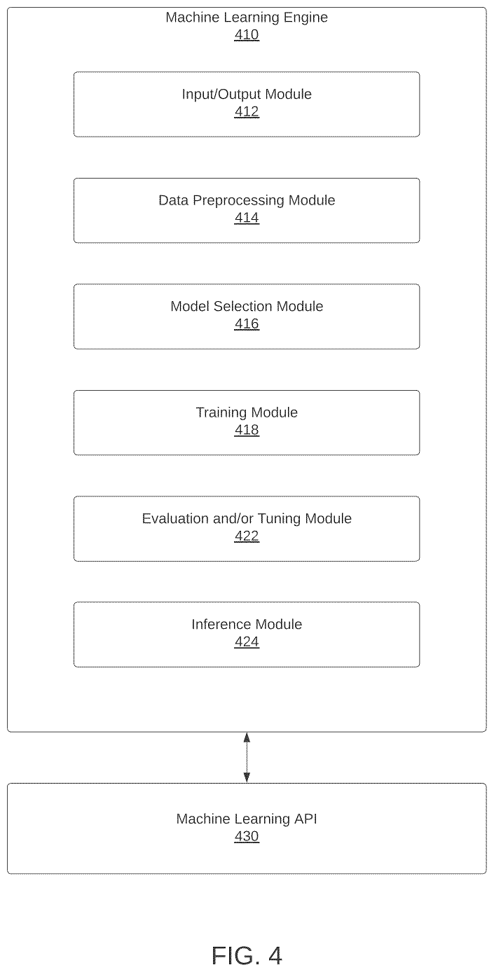

FIG. 4 illustrates a machine learning engine 410 in accordance with one or more embodiments. As illustrated in FIG. 4, machine learning engine 410 includes input/output module 412, data preprocessing module 414, model selection module 416, training module 418, evaluation and tuning module 422, and inference module 424.

In accordance with an embodiment, input/output module 412 serves as the primary interface for data entering and exiting the system, managing the flow and integrity of data. This module may accommodate a wide range of data sources and formats to facilitate integration and communication within the machine learning architecture.

In an embodiment, an input handler within input/output module 412 includes a data ingestion framework capable of interfacing with various data sources, such as databases, Application Programming Interfaces (API)s, file systems, and real-time data streams. This framework is equipped with functionalities to handle different data formats (e.g., CSV, JSON, XML) and efficiently manage large volumes of data. It includes mechanisms for batch and real-time data processing that enable the input/output module 412 to be versatile in different operational contexts whether processing historical datasets or streaming data.

In accordance with an embodiment, input/output module 412 manages data integrity and quality as it enters the system by incorporating initial checks and validations. These checks and validations ensure that incoming data meets predefined quality standards, like checking for missing values, ensuring consistency in data formats, and verifying data ranges and types. This proactive approach to data quality minimizes potential errors and inconsistencies in later stages of the machine learning process.

In an embodiment, an output handler within input/output module 412 includes an output framework designed to handle the distribution and exportation of outputs, predictions, or insights. Using the output framework, input/output module 412 formats these outputs into user-friendly and accessible formats, such as reports, visualizations, or data files compatible with other systems. Input/output module 412 also ensures secure and efficient transmission of these outputs to end-users or other systems in an embodiment and may employ encryption and secure data transfer protocols to maintain data confidentiality.

In accordance with an embodiment, data preprocessing module 414 transforms data into a format suitable for use by other modules in machine learning engine 410. For example, data preprocessing module 414 may transform raw data into a normalized or standardized format suitable for training ML models and for processing new data inputs for inference. In an embodiment, data preprocessing module 414 acts as a bridge between the raw data sources and the analytical capabilities of machine learning engine 410.

In an embodiment, data preprocessing module 414 begins by implementing a series of preprocessing steps to clean, normalize, and/or standardize the data. This involves handling a variety of anomalies, such as managing unexpected data elements, recognizing inconsistencies, or dealing with missing values. Some of these anomalies can be addressed through methods, like imputation or removal of incomplete records, depending on the nature and volume of the missing data. Data preprocessing module 414 may be configured to handle anomalies in different ways depending on context. Data preprocessing module 414 also handles the normalization of numerical data in preparation for use with models sensitive to the scale of the data, like neural networks and distance-based algorithms. Normalization techniques, such as min-max scaling or z-score standardization, may be applied to bring numerical features to a common scale, enhancing the model's ability to learn effectively.

In an embodiment, data preprocessing module 414 includes a feature encoding framework that ensures categorical variables are transformed into a format that can be easily interpreted by machine learning algorithms. Techniques, such as one-hot encoding or label encoding, may be employed to convert categorical data into numerical values, making them suitable for analysis. The module may also include feature selection mechanisms, where redundant or irrelevant features are identified and removed, thereby increasing the efficiency and performance of the model.

In accordance with an embodiment, when data preprocessing module 414 processes new data for inference, data preprocessing module 414 replicates the same preprocessing steps to ensure consistency with the training data format. This helps to avoid discrepancies between the training data format and the inference data format, thereby reducing the likelihood of inaccurate or invalid model predictions.

In an embodiment, model selection module 416 includes logic for determining the most suitable algorithm or model architecture for a given dataset and problem. This module operates in part by analyzing the characteristics of the input data, such as its dimensionality, distribution, and the type of problem (classification, regression, clustering, etc.).

In an embodiment, model selection module 416 employs a variety of statistical and analytical techniques to understand data patterns, identify potential correlations, and assess the complexity of the task. Based on this analysis, it then matches the data characteristics with the strengths and weaknesses of various available models. This can range from simple linear models for less complex problems to sophisticated deep learning architectures for tasks requiring feature extraction and high-level pattern recognition, such as image and speech recognition.

In an embodiment, model selection module 416 utilizes techniques from the field of Automated Machine Learning (AutoML). AutoML systems automate the process of model selection by rapidly prototyping and evaluating multiple models. They use various techniques, like Bayesian optimization, genetic algorithms, or reinforcement learning, to explore the model space efficiently. Model selection module 416 may use these techniques to evaluate each candidate model based on performance metrics relevant to the task. For example, accuracy, precision, recall, or F1 score may be used for classification tasks, and mean squared error metrics may be used for regression tasks. Accuracy measures the proportion of correct predictions (both positive and negative). Precision measures the proportion of actual positives among the predicted positive cases. Recall (also known as sensitivity) evaluates how well the model identifies actual positives. F1 Score is a single metric that accounts for both false positives and false negatives. The mean squared error (MSE) metric may be used for regression tasks. Mean squared error measures the average squared difference between the actual and predicted values, providing an indication of the model's accuracy. A lower MSE may indicate a model's greater accuracy in predicting values, for it represents a smaller average discrepancy between the actual and predicted values.

In accordance with an embodiment, model selection module 416 also considers computational efficiency and resource constraints. This is meant to help ensure the selected model is both accurate and practical in terms of computational and time requirements. In an embodiment, certain features of model selection module 416 are configurable such as a configured bias toward (or against) computational efficiency.

In accordance with an embodiment, training module 418 manages the ‘learning’ process of ML models by implementing various learning algorithms that enable models to identify patterns and make predictions or decisions based on input data. In an embodiment, the training process begins with the preparation of the dataset after preprocessing; this involves splitting the data into training and validation sets. The training set is used to teach the model, while the validation set is used to evaluate its performance and adjust parameters accordingly. Training module 418 handles the iterative process of feeding the training data into the model, adjusting the model's internal parameters (like weights in neural networks) through backpropagation and optimization algorithms, such as stochastic gradient descent or other algorithms providing similarly useful results.

In accordance with an embodiment, training module 418 manages overfitting, where a model learns the training data too well, including its noise and outliers, at the expense of its ability to generalize to new data. Techniques, such as regularization, dropout (in neural networks), and early stopping, are implemented to mitigate this. Additionally, the module employs various techniques for hyperparameter tuning; this involves adjusting model parameters that are not directly learned from the training process, such as learning rate, the number of layers in a neural network, or the number of trees in a random forest.

In an embodiment, training module 418 includes logic to handle different types of data and learning tasks. For instance, it includes different training routines for supervised learning (where the training data comes with labels) and unsupervised learning (without labeled data). In the case of deep learning models, training module 418 also manages the complexities of training neural networks that include initializing network weights, choosing activation functions, and setting up neural network layers.

In an embodiment, evaluation and/or tuning module 422 incorporates dynamic feedback mechanisms and facilitates continuous model evolution to help ensure the system's relevance and performance as the data landscape changes. Evaluation and tuning module 422 conducts a detailed evaluation of a model's performance. This process involves using statistical methods and a variety of performance metrics to analyze the model's predictions against a validation dataset. The validation dataset, distinct from the training set, is instrumental in assessing the model's predictive accuracy and its capacity to generalize beyond the training data. The module's algorithms meticulously dissect the model's output, uncovering biases, variances, and the overall effectiveness of the model in capturing the underlying patterns of the data.

In an embodiment, evaluation and tuning module 422 performs continuous model tuning by using hyperparameter optimization. Evaluation and tuning module 422 performs an exploration of the hyperparameter space using algorithms, such as grid search, random search, or more sophisticated methods like Bayesian optimization. Evaluation and tuning module 422 uses these algorithms to iteratively adjust and refine the model's hyperparameters-settings that govern the model's learning process but are not directly learned from the data-to enhance the model's performance. This tuning process helps to balance the model's complexity with its ability to generalize and attempts to avoid the pitfalls of underfitting or overfitting.

In an embodiment, evaluation and tuning module 422 integrates data feedback and updates the model. Evaluation and tuning module 422 actively collects feedback from the model's real-world applications, an indicator of the model's performance in practical scenarios. Such feedback can come from various sources depending on the nature of the application. For example, in a user-centric application like a recommendation system, feedback might comprise user interactions, preferences, and responses. In other contexts, such as predicting events, it might involve analyzing the model's prediction errors, misclassifications, or other performance metrics in live environments.

In an embodiment, feedback integration logic within evaluation and tuning module 422 integrates this feedback using a process of assimilating new data patterns, user interactions, and error trends into the system's knowledge base. The feedback integration logic uses this information to identify shifts in data trends or emergent patterns that were not present or inadequately represented in the original training dataset. Based on this analysis, the module triggers a retraining or updating cycle for the model. If the feedback suggests minor deviations or incremental changes in data patterns, the feedback integration logic may employ incremental learning strategies, fine-tuning the model with the new data while retaining its previously learned knowledge. In cases where the feedback indicates significant shifts or the emergence of new patterns, a more comprehensive model updating process may be initiated. This process might involve revisiting the model selection process, re-evaluating the suitability of the current model architecture, and/or potentially exploring alternative models or configurations that are more attuned to the new data.

In accordance with an embodiment, throughout this iterative process of feedback integration and model updating, evaluation and tuning module 422 employs version control mechanisms to track changes, modifications, and the evolution of the model, facilitating transparency and allowing for rollback if necessary. This continuous learning and adaptation cycle, driven by real-world data and feedback, helps to endure the model's ongoing effectiveness, relevance, and accuracy.

In an embodiment, inference module 424 transforms raw data into actionable, precise, and contextually relevant predictions. In addition to processing and applying a trained model to new data, inference module 424 may also include post-processing logic that refines the raw outputs of the model into meaningful insights.

In an embodiment, inference module 424 includes classification logic that takes the probabilistic outputs of the model and converts them into definitive class labels. This process involves an analytical interpretation of the probability distribution for each class. For example, in binary classification, the classification logic may identify the class with a probability above a certain threshold, but classification logic may also consider the relative probability distribution between classes to create a more nuanced and accurate classification.

In an embodiment, inference module 424 transforms the outputs of a trained model into definitive classifications. Inference module 424 employs the underlying model as a tool to generate probabilistic outputs for each potential class. It then engages in an interpretative process to convert these probabilities into concrete class labels.

In an embodiment, when inference module 424 receives the probabilistic outputs from the model, it analyzes these probabilities to determine how they are distributed across some or every potential class. If the highest probability is not significantly greater than the others, inference module 424 may determine that there is ambiguity or interpret this as a lack of confidence displayed by the model.

In an embodiment, inference module 424 uses thresholding techniques for applications where making a definitive decision based on the highest probability might not suffice due to the critical nature of the decision. In such cases, inference module 424 assesses if the highest probability surpasses a certain confidence threshold that is predetermined based on the specific requirements of the application. If the probabilities do not meet this threshold, inference module 424 may flag the result as uncertain or defer the decision to a human expert. Inference module 424 dynamically adjusts the decision thresholds based on the sensitivity and specificity requirements of the application, subject to calibration for balancing the trade-offs between false positives and false negatives.

In accordance with an embodiment, inference module 424 contextualizes the probability distribution against the backdrop of the specific application. This involves a comparative analysis, especially in instances where multiple classes have similar probability scores, to deduce the most plausible classification. In an embodiment, inference module 424 may incorporate additional decision-making rules or contextual information to guide this analysis, ensuring that the classification aligns with the practical and contextual nuances of the application.

In regression models, where the outputs are continuous values, inference module 424 may engage in a detailed scaling process in an embodiment. Outputs, often normalized or standardized during training for optimal model performance, are rescaled back to their original range. This rescaling involves recalibration of the output values using the original data's statistical parameters, such as mean and standard deviation, ensuring that the predictions are meaningful and comparable to the real-world scales they represent.

In an embodiment, inference module 424 incorporates domain-specific adjustments into its post-processing routine. This involves tailoring the model's output to align with specific industry knowledge or contextual information. For example, in financial forecasting, inference module 424 may adjust predictions based on current market trends, economic indicators, or recent significant events, ensuring that the outputs are both statistically accurate and practically relevant.

In an embodiment, inference module 424 includes logic to handle uncertainty and ambiguity in the model's predictions. In cases where inference module 424 outputs a measure of uncertainty, such as in Bayesian inference models, inference module 424 interprets these uncertainty measures by converting probabilistic distributions or confidence intervals into a format that can be easily understood and acted upon. This provides users with both a prediction and an insight into the confidence level of that prediction. In an embodiment, inference module 424 includes mechanisms for involving human oversight or integrating the instance into a feedback loop for subsequent analysis and model refinement.

In an embodiment, inference module 424 formats the final predictions for end-user consumption. Predictions are converted into visualizations, user-friendly reports, or interactive interfaces. In some systems, like recommendation engines, inference module 424 also integrates feedback mechanisms, where user responses to the predictions are used to continually refine and improve the model, creating a dynamic, self-improving system.

The machine learning engine API 430 is an interface that facilitates access to and interaction with the machine learning engine 410 by other modules and/or components of a system.

### 6. Machine Learning Operations

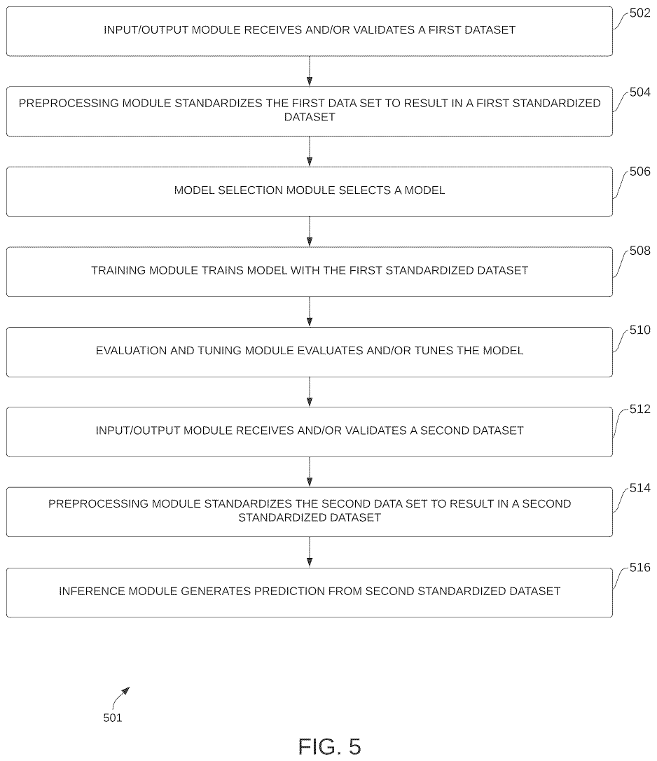

FIG. 5 illustrates a set of machine learning operations 500. In embodiments, one or more operations of the set of operations 500 is performed by a machine learning engine such as machine learning engine 410. In an embodiment, input/output module 412 receives a dataset intended for training (Operation 502). This data can originate from diverse sources, like databases or real-time data streams, and in varied formats, such as CSV, JSON, or XML. Input/output module 412 assesses and validates the data, ensuring its integrity by checking for consistency, data ranges, and types.

In an embodiment, training data is passed to data preprocessing module 414. Here, the data undergoes a series of transformations to standardize and clean it, making it suitable for training ML models (Operation 504). This involves normalizing numerical data, encoding categorical variables, and handling missing values through techniques like imputation.

In an embodiment, prepared data from the data preprocessing module 414 is then fed into model selection module 416 (Operation 506). This module analyzes the characteristics of the processed data, such as dimensionality and distribution, and selects the most appropriate model architecture for the given dataset and problem. It employs statistical and analytical techniques to match the data with an optimal model, ranging from simpler models for less complex tasks to more advanced architectures for intricate tasks.

In an embodiment, training module 418 trains the selected model with the prepared dataset (Operation 508). It implements learning algorithms to adjust the model's internal parameters, optimizing them to identify patterns and relationships in the training data. Training module 418 also addresses the challenge of overfitting by implementing techniques, like regularization and early stopping, ensuring the model's generalizability.

In an embodiment, evaluation and tuning module 422 evaluates the trained model's performance using the validation dataset (Operation 510). Evaluation and tuning module 422 applies various metrics to assess predictive accuracy and generalization capabilities. It then tunes the model by adjusting hyperparameters, and if needed, incorporates feedback from the model's initial deployments, retraining the model with new data patterns identified from the feedback.

In an embodiment, input/output module 412 receives a dataset intended for inference. Input/output module 412 assesses and validates the data (Operation 512).

In an embodiment, data preprocessing module 414 receives the validated dataset intended for inference (Operation 514). Data preprocessing module 414 ensures that the data format used in training is replicated for the new inference data, maintaining consistency and accuracy for the model's predictions.

In an embodiment, inference module 424 processes the new data set intended for inference, using the trained and tuned model (Operation 516). It applies the model to this data, generating raw probabilistic outputs for predictions. Inference module 424 then executes a series of post-processing steps on these outputs, such as converting probabilities to class labels in classification tasks or rescaling values in regression tasks. It contextualizes the outputs as per the application's requirements, handling any uncertainty in predictions and formatting the final outputs for end-user consumption or integration into larger systems.

In an embodiment, machine learning engine API 430 helps applications to leverage the machine learning engine 410. In an embodiment, machine learning engine API 430 may be built on a RESTful architecture and offer stateless interactions over standard HTTP/HTTPS protocols. Machine learning engine API 430 may feature a variety of endpoints, each tailored to a specific function within machine learning engine 410. In an embodiment, endpoints such as “/submitData” facilitate the submission of new data for processing, while endpoints such as “/retrieveResults fetch the outcomes of data analysis or model predictions. Message level encryption (MLE) API also includes endpoints, such as “/updateModel” for model modifications and “/trainModel” to initiate training with new datasets.

In an embodiment, machine learning engine API 430 is equipped to support SOAP-based interactions. This extension involves defining a Web Services Description Language (WSDL) document that outlines the API's operations and the structure of request and response messages. In an embodiment, machine learning engine API 430 supports various data formats and communication styles. In an embodiment, machine learning engine API 430 endpoints may handle requests in JSON format or any other suitable format. For example, machine learning engine API 430 may process XML, and it may also be engineered to handle more compact and efficient data formats, such as Protocol Buffers or Avro, for use in bandwidth-limited scenarios.

In an embodiment, machine learning engine API 430 is designed to integrate WebSocket technology for applications necessitating real-time data processing and immediate feedback. This integration enables a continuous, bi-directional communication channel for a dynamic and interactive data exchange between the application and machine learning engine 410.

### 7. Generative Artificial Intelligence Models

A generative model is a machine learning model that is capable of generating new data instances based on the data used to train the model. A generative model may be referred to as a “generative artificial intelligence (AI) model.” Generative models learn the underlying distribution of the training data, enabling them to produce new instances of data that share properties with the original dataset. This capability makes them particularly useful in a variety of applications, including image and voice generation, text synthesis, and more sophisticated tasks, such as unsupervised learning, semi-supervised learning, and domain adaptation.

Large language models are designed to understand, generate, and interpret human language by processing extensive collections of data. The foundational architecture behind LLMs is the transformer network, a type of neural network that excels in handling sequential data such as text. Unlike certain architectures, such as recurrent neural networks (RNNs) or long short-term memory networks (LSTMs), transformers do not process data in order. Instead, they leverage parallel processing to analyze entire text sequences simultaneously, significantly improving efficiency and reducing training times.

In an embodiment, a mechanism that enables transformers to handle complex language tasks is self-attention. This mechanism allows the model to weigh the importance of different words within a sentence or sequence regardless of their position. For instance, in processing the phrase “The cat sat on the mat,” the model can directly associate “cat” with “mat” without having to process the intermediate words sequentially. This ability to understand the context and relationships between words in a sentence is what makes transformer networks adept at language tasks. The self-attention mechanism assigns scores to relationships between words, highlighting the most relevant connections, so the model can focus on the most informative parts of the text.

In accordance with one or more embodiments, transformers are composed of multiple layers including a multi-head, self-attention mechanism and a position-wise, feed-forward network. Within the architecture of transformer models, the multi-head, self-attention mechanism and position-wise, feed-forward network function in concert to process input data. The multi-head, self-attention mechanism is designed to enable parallel processing of input sequences, allowing the model to simultaneously evaluate the importance of different segments of the input relative to each other. This mechanism operates by generating multiple sets of query, key, and value vectors for each element in the input sequence through linear transformation. The relevance of each element to other elements is calculated using a scaled dot-product attention function that computes the attention scores by taking the dot product of the query vector with the key vectors, dividing each by the square root of the dimension of the key vectors to scale the scores, then applying a “SoftMax” function to obtain the weights for the value vectors. The scaled dot-product attention function is applied independently by each head in the multi-head, self-attention mechanism. The outputs of these heads are then concatenated and linearly transformed, allowing the model to capture information from different representation subspaces.

In accordance with one or more embodiments, following the multi-head, self-attention mechanism is the position-wise, feed-forward network. This component comprises two linear transformations with a non-linear activation function in between. Each element of the input sequence, now enriched with context by the self-attention mechanism, is processed independently through the same feed-forward network. The first linear transformation increases the dimensionality of the input, allowing for a richer representation space. The non-linear activation function introduces the capability to capture non-linear relationships within the data. The second linear transformation then reduces the dimensionality back to that of the model's hidden layers, preparing the output for either further processing by subsequent layers or final output generation. This sequence of operations is applied to each position in the sequence, so the model can learn complex patterns across different parts of the input data without relying on the sequential processing inherent to previous architectures, such as RNNs or LSTMs.

In accordance with one or more embodiments, integrating these components within the transformer architecture facilitates the model's ability to understand and generate human language by leveraging both the global context provided by the self-attention mechanism and the local, position-specific transformations applied by the feed-forward networks. Through the repetitive stacking of layers, transformers achieve a depth of representation that allows for the processing of linguistic information across varying levels of complexity.

In accordance with one or more embodiments, input/output module 412, when used for LLMs, handles textual data, converting input text into a format that the model can process. This typically involves tokenization, where the text is broken down into manageable pieces, such as words or subwords, and then converted into numerical representations. These representations, or embeddings, capture semantic information about the text that is then fed into the model for processing. The output from the model is converted from numerical form back into human-readable text, following the generation of predictions or responses.

In accordance with one or more embodiments, data preprocessing module 414 in the context of LLMs may include steps, such as normalization, where the text is converted to a uniform case and punctuation is standardized. This process ensures that the model treats similar words or symbols consistently, reducing the complexity of the input space. Additionally, techniques, such as sentence segmentation, may be applied to manage longer texts, enabling the model to process information in chunks that align with natural language structures.

In accordance with one or more embodiments, model selection module 416, when used for LLMs, involves choosing a specific architecture and configuration that is best suited to the task at hand. This decision is based on various factors, such as the size of the available training data, the complexity of the language tasks to be performed, and computational resource constraints. Models may vary in size from millions to billions of parameters, with larger models generally capable of more nuanced language understanding and generation but requiring significantly more computational power to train and operate.

In accordance with one or more embodiments, training module 418, when used for LLMs, is configured to adjust the model's parameters through exposure to training data. This process utilizes optimization algorithms, such as stochastic gradient descent, to minimize the difference between the model's predictions and the actual desired outputs. The training process is computationally intensive, often requiring specialized hardware, such as GPUs (Graphics Processing Units) or TPUs (Tensor Processing Units), to manage the large volumes of data and the complexity of the model calculations. During training, techniques, such as dropout and layer normalization, are used to improve model generalization and prevent overfitting (i.e., when a model learns the detail and noise in the training data to the extent that it negatively impacts the model's performance on new data).

In accordance with one or more embodiments, evaluation and tuning module 422 assesses the performance of LLMs using metrics, such as perplexity, accuracy, and F1 score, depending on the specific language tasks. Evaluation may involve comparing the model's output against a set of labeled validation data, providing insight into how well the model has learned to perform tasks, such as text classification, question answering, or text generation. Tuning involves adjusting model parameters or training strategies based on evaluation outcomes to improve performance. This may include hyperparameter tuning, where parameters that govern the training process, such as learning rate or batch size, are adjusted.

In accordance with one or more embodiments, inference module 424, in the context of LLMs, is responsible for generating predictions or responses based on new, unseen data. This process involves feeding the input data through the trained model to produce an output. Inference can be used for a variety of applications, including translating text, generating human-like responses in a chatbot, or summarizing articles.

Another type of generative model is a large multimodal model (LMM). An LMM is an advanced machine learning model capable of processing and generating data across multiple modalities, such as text, images, audio, and video. These models integrate diverse datasets during training to learn the underlying distribution of different data types, enabling them to produce outputs that reflect a comprehensive understanding of the input data. These models can be used for numerous applications, such as image captioning, text-to-image generation, image-to-text generation, visual question answering, and more, where understanding the relationship between different data types is crucial. By leveraging diverse datasets during training, LMMs learn to create coherent and contextually relevant outputs across various modalities, enhancing their utility in complex, real-world scenarios.

The architecture of LLMs combines elements from different neural network designs to handle diverse data types effectively. For example, convolutional neural networks (CNNs) are often used for processing visual data, while transformer networks handle textual data, enabling the model to extract and synthesize features from both images and text. This integration results in outputs that accurately represent the input data, reflecting a deep understanding of both modalities. The transformer architecture, known for its ability to manage sequential data, is frequently adapted to work alongside CNNs, allowing these models to benefit from the strengths of each neural network type.

In at least some instances, the self-attention mechanism, a cornerstone of transformer networks, is integral to the functioning of LMMs. It enables the model to weigh the importance of different elements within an input sequence, regardless of their position, allowing it to capture intricate relationships between various data types. For example, in an image captioning task, the model can associate specific visual features with corresponding descriptive text, enhancing the coherence and accuracy of the generated captions. By assigning scores to relationships between elements, the self-attention mechanism highlights the most relevant connections, enabling the model to focus on the most informative parts of the input data and perform complex multimodal tasks effectively.

In LMMs, data preprocessing is a step that ensures the input data is in a suitable format for the model to process. This involves tasks, such as tokenization for text data, where the text is broken down into manageable pieces, and feature extraction for image data, where key visual elements are identified and encoded. By standardizing and normalizing different data types, preprocessing reduces the complexity of the input space, enabling the model to treat similar elements consistently. Effective preprocessing is essential for the model to integrate information from various modalities and produce accurate, meaningful outputs.

Training LMMs involves optimizing their parameters through exposure to diverse datasets that include paired data from different modalities. This computationally intensive process often requires specialized hardware, like GPUs or TPUs, to manage the large volumes of data and the complexity of the model calculations. Techniques, such as dropout and layer normalization, are employed to improve model generalization and prevent overfitting. By iteratively adjusting the model's parameters, the training process enables the model to learn underlying patterns and relationships within the data, enhancing its ability to generate coherent and contextually relevant outputs across different modalities.

Evaluation and tuning of LMMs are conducted using various metrics tailored to the specific tasks they are designed to perform. For example, Bilingual Evaluation Understudy scores are used for text generation tasks, while accuracy is commonly applied for visual recognition tasks to assess performance. Tuning involves adjusting hyperparameters and refining training strategies based on evaluation results to enhance the model's effectiveness. This iterative process ensures that the model can perform a wide range of multimodal tasks with high accuracy and relevance, making it a versatile tool for applications requiring the integration of different types of data.

Large multimodal models represent a significant advancement in machine learning by leveraging sophisticated architectures that combine different neural network types and apply self-attention mechanisms. This enables them to perform complex tasks that require understanding and synthesizing information from diverse data types. Effective preprocessing, rigorous training, and thorough evaluation are crucial to their success, allowing these models to generate coherent and contextually relevant outputs across a wide range of applications.

In accordance with one or more embodiments, other types of models besides LLMs and LMMs belong to the broad category of generative models. For example, stochastic models directly incorporate randomness into their structure, making them inherently generative as they can produce a diverse set of outputs for a given input. Generative Adversarial Networks (GANs) learn to generate new data that is indistinguishable from the data they were trained on, using a dual-network architecture that involves a generative component. Variational Autoencoders (VAEs) are designed for generating new data points by learning a distribution of some input data, by encoding inputs into a latent space, and/or by generating outputs by sampling from a latent space. An example VAE is therefore inherently generative. Sequence-to-sequence models are generative in nature when used with sampling strategies. Although this list of generative model types is not exhaustive, it illustrates the broad use of the term generative model beyond LLMs.

Although generative models can be leveraged for classification tasks, they inherently operate on principles of randomness, leading to a spectrum of possible outcomes in response to identical inputs. Unlike deterministic models that yield a consistent result whenever the same input is given, generative models use the randomness in the data they are trained on to both mimic and diversify from the training data. This diversity makes generative models ideal for generating new and varied data points as well as for tasks that require creativity and novelty. However, a reliance on randomness creates a trade-off between predictability and flexibility for generative models, potentially making them less predictable in scenarios where uniform outcomes may be expected such as classification tasks.

### 8. Computer Networks and Cloud Networks

In one or more embodiments, a computer network provides connectivity among a set of nodes. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (“NAT”). Another subset of nodes uses the computer network. Such nodes (also referred to as “hosts”) may execute a client process and/or a server process. A client process makes a request for a computing service (such as, execution of a particular application, and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network (such as, a physical network). Each node in an overlay network corresponds to a respective node in the underlying network. Hence, each node in an overlay network is associated with both an overlay address (to address to the overlay node) and an underlay address (to address the underlay node that implements the overlay node). An overlay node may be a digital device and/or a software process (such as, a virtual machine, an application instance, or a thread) A link that connects overlay nodes is implemented as a tunnel through the underlying network. The overlay nodes at either end of the tunnel treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol, such as Hypertext Transfer Protocol (HTTP). The requests are communicated through an interface, such as a client interface (such as a web browser), a program interface, or an application programming interface (API).

In an embodiment, a computer network provides connectivity between clients and network resources. Network resources include hardware and/or software configured to execute server processes. Examples of network resources include a processor, a data storage, a virtual machine, a container, and/or a software application. Network resources are shared amongst multiple clients. Clients request computing services from a computer network independently of each other. Network resources are dynamically assigned to the requests and/or clients on an on-demand basis.

Network resources assigned to each request and/or client may be scaled up or down based on, for example, (a) the computing services requested by a particular client, (b) the aggregated computing services requested by a particular tenant, and/or (c) the aggregated computing services requested of the computer network. Such a computer network may be referred to as a “cloud network.”

In an embodiment, a service provider provides a taxonomic negative sampling-based machine learning system via a cloud network to one or more end users. Various service models may be implemented by the cloud network, including but not limited to Software-as-a-Service (SaaS), Platform-as-a-Service (PaaS), and Infrastructure-as-a-Service (IaaS). In SaaS, a service provider provides end users the capability to use the service provider's applications, which are executing on the network resources. In PaaS, the service provider provides end users the capability to deploy custom applications onto the network resources. The custom applications may be created using programming languages, libraries, services, and tools supported by the service provider. In IaaS, the service provider provides end users the capability to provision processing, storage, networks, and other fundamental computing resources provided by the network resources. Any arbitrary applications, including an operating system, may be deployed on the network resources.

In an embodiment, various deployment versions of a taxonomic negative sampling-based machine learning system may be implemented by a computer network, including but not limited to a private cloud, a public cloud, and a hybrid cloud. In a private cloud, network resources are provisioned for exclusive use by a particular group of one or more entities (the term “entity” as used herein refers to a corporation, organization, person, or other entity). The network resources may be local to and/or remote from the premises of the particular group of entities. In a public cloud, cloud resources are provisioned for multiple entities that are independent from each other (also referred to as “tenants” or “customers”). The computer network and the network resources thereof are accessed by clients corresponding to different tenants. Such a computer network may be referred to as a “multi-tenant computer network.” Several tenants may use a same particular network resource at different times and/or at the same time. The network resources may be local to and/or remote from the premises of the tenants. In a hybrid cloud, a computer network comprises a private cloud and a public cloud. An interface between the private cloud and the public cloud allows for data and application portability. Data stored at the private cloud and data stored at the public cloud may be exchanged through the interface. Applications implemented at the private cloud and applications implemented at the public cloud may have dependencies on each other. A call from an application at the private cloud to an application at the public cloud (and vice versa) may be executed through the interface.

In an embodiment, tenants of a multi-tenant computer network are independent of each other. For example, a business or operation of one tenant may be separate from a business or operation of another tenant. Different tenants may demand different network requirements for the computer network. Examples of network requirements include processing speed, amount of data storage, security requirements, performance requirements, throughput requirements, latency requirements, resiliency requirements, Quality of Service (QoS) requirements, tenant isolation, and/or consistency. The same computer network may need to implement different network requirements demanded by different tenants.

In one or more embodiments, in a multi-tenant computer network, tenant isolation is implemented to ensure that the applications and/or data of different tenants are not shared with each other. Various tenant isolation approaches may be used.

In an embodiment, each tenant is associated with a tenant ID. Each network resource of the multi-tenant computer network is tagged with a tenant ID. A tenant is permitted access to a particular network resource only if the tenant and the particular network resources are associated with a same tenant ID.

In an embodiment, each tenant is associated with a tenant ID. Each application, implemented by the computer network, is tagged with a tenant ID. Additionally, or alternatively, each data structure and/or dataset, stored by the computer network, is tagged with a tenant ID. A tenant is permitted access to a particular application, data structure, and/or dataset only if the tenant and the particular application, data structure, and/or dataset are associated with a same tenant ID.

As an example, each database implemented by a multi-tenant computer network may be tagged with a tenant ID. Only a tenant associated with the corresponding tenant ID may access data of a particular database. As another example, each entry in a database implemented by a multi-tenant computer network may be tagged with a tenant ID. Only a tenant associated with the corresponding tenant ID may access data of a particular entry. However, multiple tenants may share the database.

In an embodiment, a subscription list indicates which tenants have authorization to access which applications. For each application, a list of tenant IDs of tenants authorized to access the application is stored. A tenant is permitted access to a particular application only if the tenant ID of the tenant is included in the subscription list corresponding to the particular application.

In an embodiment, network resources (such as digital devices, virtual machines, application instances, and threads) corresponding to different tenants are isolated to tenant-specific overlay networks maintained by the multi-tenant computer network. As an example, packets from any source device in a tenant overlay network may only be transmitted to other devices within the same tenant overlay network. Encapsulation tunnels are used to prohibit any transmissions from a source device on a tenant overlay network to devices in other tenant overlay networks. Specifically, the packets, received from the source device, are encapsulated within an outer packet. The outer packet is transmitted from a first encapsulation tunnel endpoint (in communication with the source device in the tenant overlay network) to a second encapsulation tunnel endpoint (in communication with the destination device in the tenant overlay network). The second encapsulation tunnel endpoint decapsulates the outer packet to obtain the original packet transmitted by the source device. The original packet is transmitted from the second encapsulation tunnel endpoint to the destination device in the same particular overlay network.

### 9. Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

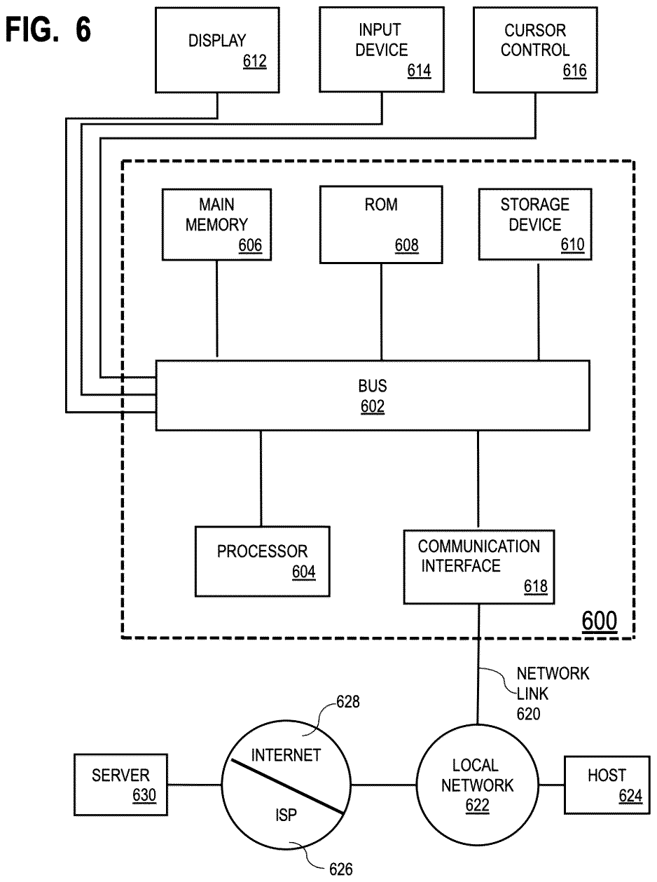

For example, FIG. 6 is a block diagram that illustrates a computer system 600 upon which an embodiment of the disclosure may be implemented. Computer system 600 includes a bus 602 or other communication mechanism for communicating information, and a hardware processor 604 coupled with bus 602 for processing information. Hardware processor 604 may be, for example, a general-purpose microprocessor.

Computer system 600 also includes a main memory 606, such as a random access memory (RAM) or other dynamic storage device, coupled to bus 602 for storing information and instructions to be executed by processor 604. Main memory 606 also may be used for storing temporary variables or other intermediate information during execution of instructions to be executed by processor 604. Such instructions, when stored in non-transitory storage media accessible to processor 604, render computer system 600 into a special-purpose machine that is customized to perform the operations specified in the instructions.

Computer system 600 further includes a read only memory (ROM) 608 or other static storage device coupled to bus 602 for storing static information and instructions for processor 604. A storage device 610, such as a magnetic disk, optical disk, or a Solid State Drive (SSD) is provided and coupled to bus 602 for storing information and instructions.

Computer system 600 may be coupled via bus 602 to a display 612, such as a cathode ray tube (CRT), for displaying information to a computer user. An input device 614, including alphanumeric and other keys, is coupled to bus 602 for communicating information and command selections to processor 604. Another type of user input device is cursor control 616, such as a mouse, a trackball, or cursor direction keys for communicating direction information and command selections to processor 604 and for controlling cursor movement on display 612. This input device typically has two degrees of freedom in two axes, a first axis (e.g., x) and a second axis (e.g., y), that allows the device to specify positions in a plane.

Computer system 600 may implement the techniques described herein using customized hard-wired logic, one or more ASICs or FPGAs, firmware and/or program logic which in combination with the computer system causes or programs computer system 600 to be a special-purpose machine. According to one embodiment, the techniques herein are performed by computer system 600 in response to processor 604 executing one or more sequences of one or more instructions contained in main memory 606. Such instructions may be read into main memory 606 from another storage medium, such as storage device 610. Execution of the sequences of instructions contained in main memory 606 causes processor 604 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 610. Volatile media includes dynamic memory, such as main memory 606. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 602. Transmission media can also take the form of acoustic or light waves, such as those generated during radio-wave and infra-red data communications.

Various forms of media may be involved in carrying one or more sequences of one or more instructions to processor 604 for execution. For example, the instructions may initially be carried on a magnetic disk or solid state drive of a remote computer. The remote computer can load the instructions into its dynamic memory and send the instructions over a telephone line using a modem. A modem local to computer system 600 can receive the data on the telephone line and use an infra-red transmitter to convert the data to an infra-red signal. An infra-red detector can receive the data carried in the infra-red signal and appropriate circuitry can place the data on bus 602. Bus 602 carries the data to main memory 606, from which processor 604 retrieves and executes the instructions. The instructions received by main memory 606 may optionally be stored on storage device 610 either before or after execution by processor 604.

Computer system 600 also includes a communication interface 618 coupled to bus 602 Communication interface 618 provides a two-way data communication coupling to a network link 620 that is connected to a local network 622. For example, communication interface 618 may be an integrated services digital network (ISDN) card, cable modem, satellite modem, or a modem to provide a data communication connection to a corresponding type of telephone line. As another example, communication interface 618 may be a local area network (LAN) card to provide a data communication connection to a compatible LAN. Wireless links may also be implemented. In any such implementation, communication interface 618 sends and receives electrical, electromagnetic or optical signals that carry digital data streams representing various types of information.

Network link 620 typically provides data communication through one or more networks to other data devices. For example, network link 620 may provide a connection through local network 622 to a host computer 624 or to data equipment operated by an Internet Service Provider (ISP) 626. ISP 626 in turn provides data communication services through the world wide packet data communication network now commonly referred to as the “Internet” 628. Local network 622 and Internet 628 both use electrical, electromagnetic or optical signals that carry digital data streams. The signals through the various networks and the signals on network link 620 and through communication interface 618, which carry the digital data to and from computer system 600, are example forms of transmission media.

Computer system 600 can send messages and receive data, including program code, through the network(s), network link 620 and communication interface 618. In the Internet example, a server 630 might transmit a requested code for an application program through Internet 628, ISP 626, local network 622 and communication interface 618.

The received code may be executed by processor 604 as it is received, and/or stored in storage device 610, or other non-volatile storage for later execution.

### 10. Miscellaneous; Extensions

Unless otherwise defined, all terms (including technical and scientific terms) are to be given their ordinary and customary meaning to a person of ordinary skill in the art, and are not to be limited to a special or customized meaning unless expressly so defined herein.

This application may include references to certain trademarks. Although the use of trademarks is permissible in patent applications, the proprietary nature of the marks should be respected and every effort made to prevent their use in any manner which might adversely affect their validity as trademarks.

Embodiments are directed to a system with one or more devices that include a hardware processor and that are configured to perform any of the operations described herein and/or recited in any of the claims below.

In an embodiment, one or more non-transitory computer readable storage media comprises instructions which, when executed by one or more hardware processors, cause performance of any of the operations described herein and/or recited in any of the claims.

In an embodiment, a method comprises operations described herein and/or recited in any of the claims, the method being executed by at least one device including a hardware processor.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction.

What is claimed is:

1. A method comprising:
defining a batch of data points including a first data point and a second data point by:
accessing (a) a first instruction within a prompt to perform a first language task involving a first language, (b) one or more resources in the first language, (c) a second instruction within the prompt to perform a second language task involving a second language, and (d) one or more resources in the second language, the one or more resources in the second language having semantically similar content relative to the one or more resources in the first language;
constructing the first data point of the batch of data points based on the prompt, the first language task and the one or more resources in the first language; and
constructing the second data point of the batch of data points based on the prompt, the second language task, and the one or more resources in the second language;
inputting the batch of data points into a learning framework to produce an optimized language model; and
storing the optimized language model at one or more storage devices;
wherein the method is performed on a device comprising at least one hardware processor.

2. The method of claim 1, wherein:
the first language task comprises at least one of: answering a first query in the first language or predicting a first ground truth in the first language;
the second language task comprises at least one of: answering a second query in the second language or predicting a second ground truth in the second language;
the first data point comprises a first answer based on (a) the at least one of the first query in the first language or the first ground truth and (b) the one or more resources in the first language; and
the second data point comprises a second answer based on (a) the at least one of the second query in the second language or the second ground truth and (b) the one or more resources in the second language.

3. The method of claim 1, wherein:
the first language is a high resource language for the learning framework;
the second language is not a high resource language for the learning framework; and
the prompt includes instructions in the first language requesting that the first language task be performed and requesting that the second language task be performed.

4. The method of claim 1, wherein:
the first language task comprises at least one of: answering a first query in the first language or predicting a first ground truth in the first language;
the second language task comprises at least one of: answering a second query in the first language or predicting a second ground truth in the first language.

5. The method of claim 1, wherein:
the prompt further comprises:
a third language task comprising at least one of: answering a third query in a third language or predicting a third ground truth in the third language;
one or more resources in the third language, the one or more resources in the third language being semantically equivalent to the one or more resources in the first language and the one or more resources in the second language;
the method further comprising:
generating a third data point of the batch of data points based on the prompt, the third language task, and the one or more resources in the third language.

6. The method of claim 1, wherein:
the prompt comprises a first query in the first language and a second query in the second language that is semantically equivalent to the first query.

7. The method of claim 1, wherein:
the prompt comprises at least one of: (a) a first ground truth for the first language task and the second language task or (b) a first ground truth for the first language task in the first language and a second ground truth for the second language task in the second language, the second ground truth being semantically equivalent to the first ground truth.

8. The method of claim 1, wherein:
the prompt in the first language comprises a semantic query in the first language, the prompt in the second language comprise a semantic query in the second language, the one or more resources in the first language include a first text in the first language, and the one or more resources in the second language include a second text in the second language, and the first text and the second text are semantically equivalent.

9. The method of claim 1, wherein:
the one or more resources in the first language include a first conversation in the first language;
the one or more resources in the second language include a second conversation in the second language that is semantically equivalent to the first conversation;
the first data point includes a first indication whether a first answer to a first request in the prompt to predict a first missing phrase for the first conversation matches a ground truth in the first language; and
the second data point includes a second indication whether a second answer to a second request to predict a second missing phrase for the second conversation matches a ground truth in the second language;
the method further comprising:
obtaining, from a language model:
the first answer based on the first request in the prompt to predict the first missing phrase for the first conversation; and
the second answer based on the second request in the prompt to predict the second missing phrase for the second conversation.

10. The method of claim 1, wherein:
the one or more resources in the first language comprises a first set of document chunks in the first language;
the one or more resources in the second language comprises a second set of document chunks in the second language that are semantically equivalent to the first set of document chunks;
the prompt comprises a request to (a) determine if a first answer to a first query in the first language is included in the first set of document chunks and (b) determine if a second answer to a second query in the second language is included in the second set of document chunks, the first query in the first language being semantically equivalent to the second query in the second language.

11. The method of claim 1, wherein:
the first data point comprises: (a) a prompt in the first language, (b) a resource in the first language including a valid response to the prompt in the first language, and (c) one or more resources in the first language not including the valid response to the prompt in the first language; and
the second data point comprises: (a) a prompt in the second language, (b) a resource in the second language including a valid response to the prompt in the second language, and (c) one or more resources in the second language not including the valid response to the prompt in the second language.

12. The method of claim 1, further comprising:
accessing second batch of data points including:
a first negative data point comprising: (a) a query in the first language, and (b) a plurality of resources in the first language not including a valid response to the query in the first language; and
a second negative data point comprising: (a) a query in the second language and (b) a plurality of resources in the second language not including a valid response to the query in the second language; and
inputting the second batch of data points into the learning framework to produce the optimized language model.

13. The method of claim 1, wherein:
the one or more resources in the first language and the one or more resources in the second language are related to a first topic; the method further comprising:
accessing a first negative data point, the first negative data point comprising: (a) the prompt in the first language, and (b) a plurality of resources in the first language related to the first topic that do not enable a valid response; and
accessing a second negative data point, the second negative data point comprising: (a) the prompt in the second language, and (b) a plurality of resources in the second language related to the first topic that do not enable a valid response to the prompt.

14. The method of claim 1, wherein:
the one or more resources in the first language and the one or more resources in the second language are related to a first topic or first conversation; the method further comprising:
accessing a first negative data point, the first negative data point comprising: (a) the prompt in the first language, and (b) a plurality of resources in the first language not related to the first topic or first conversation; and
accessing a second negative data point, the second negative data point comprising: (a) the prompt in the second language, and (b) a plurality of resources in the second language not related to the first topic or first conversation.

15. The method of claim 1, further comprising:
generating the batch of data points by:
identifying a topic associated with a plurality of resources;
selecting the one or more resources in the first language based on the one or more resources in the first language being associated with the topic;
selecting the one or more resources in the second language based on the one or more resources in the second language being associated with the topic;
generating a first query associated with the topic and a second query associated with the topic; and
storing a first plurality of data points in a first batch of data points based on generating a first plurality of answers by inputting the first query into a pretrained language model;
storing a second plurality of data points in a second batch of data points based on generating a second plurality of answers by inputting the second query into the pretrained language model; and
performing reinforcement learning to result in the optimized language model by using the first batch of data points and the second batch of data points as alignment training data to optimize the pretrained language model.

16. The method of claim 1, wherein:
inputting the batch of data points into the learning framework to produce the optimized language model comprises performing reinforcement learning during an initial training phase to result in the optimized language model.

17. The method of claim 1:
wherein the first language is a high resource language for a pretrained generative language model previously trained with the high resource language; and
wherein inputting the batch of data points into the learning framework to produce the optimized language model comprises performing reinforcement learning, on the pretrained generative language model previously trained with the high resource language, to result in the optimized language model.

18. The method of claim 16, further comprising:
measuring a first performance score of a pretrained generative language model;
inputting the first data point and the second data point as training data into a plurality of reinforcement learning frameworks;
subsequently measuring a plurality of performance scores of a plurality of reinforced language models respectively corresponding to the plurality of reinforcement learning frameworks being used to optimize one or more versions of the pretrained generative language model; and
selecting a reinforcement learning framework having a higher performance score than the first performance score based on the higher performance score being greater than one or more other scores of the plurality of performance scores.

19. One or more non-transitory computer readable media comprising instructions which, when executed by one or more hardware processors, cause performance of operations comprising:
defining a batch of data points comprising a first data point and a second data point by:
accessing (a) a first instruction within a prompt to perform a first language task involving a first language, (b) one or more resources in the first language, (c) a second instruction within the prompt to perform a second language task involving a second language, and (d) one or more resources in the second language, the one or more resources in the second language having semantically similar content relative to the one or more resources in the first language;
constructing the first data point of the batch of data points based on the prompt, the first language task and the one or more resources in the first language; and
constructing the second data point of the batch of data points based on the prompt, the second language task, and the one or more resources in the second language;
inputting the batch of data points into a learning framework to produce an optimized language model; and
storing the optimized language model at one or more storage devices; wherein
the first language task comprises at least one of: answering a first query in the first language or predicting a first ground truth in the first language;
the second language task comprises at least one of: answering a second query in the second language or predicting a second ground truth in the second language;
the first data point comprises a first answer based on (a) the at least one of the first query in the first language or the first ground truth and (b) the one or more resources in the first language;
the second data point comprises a second answer based on (a) the at least one of the second query in the second language or the second ground truth and (b) the one or more resources in the second language.

20. A system, comprising:
at least one device including a hardware processor;
the system being configured to perform operations comprising:
defining a batch of data points comprising a first data point and a second data point by:
accessing (a) a first instruction within a prompt to perform a first language task involving a first language, (b) one or more resources in the first language, (c) a second instruction within the prompt to perform a second language task involving a second language, and (d) one or more resources in the second language, the one or more resources in the second language having semantically similar content relative to the one or more resources in the first language;
constructing the first data point of the batch of data points based on the prompt, the first language task and the one or more resources in the first language; and
constructing the second data point of the batch of data points based on the prompt, the second language task, and the one or more resources in the second language;
inputting the batch of data points into a learning framework to produce an optimized language model; and
storing the optimized language model at one or more storage devices.
